(19) United States
(12) Patent Application Publication
(10) Pub. No.: US 2019/0072398 A1
(43) Pub. Date: Mar. 7, 2019

(54) NAVIGATION USING MULTIPLE USER TRIP PLAN INTEGRATION

(71) Applicant: HERE Global B.V., Eindhoven (NL)

(72) Inventor: Arun Balakrishna, Frankfurt (DE)

(21) Appl. No.: 15/695,616

(22) Filed: Sep. 5, 2017

(51) Int. Cl. G01C 21/34; G01C 21/36; G05D 1/02

(52) U.S. Cl. CPC G01C 21/3415; G01C 21/3484; G01C 21/343; G01C 21/362; G01C 21/3469; G05D 1/0088; G01C 21/3691; G05D 1/0276; G01C 21/3438; G01C 21/3676; G05D 2201/0213; G01C 21/3492

(57) ABSTRACT

Trip plan data corresponding to a first trip to be taken by a first user is received from a user apparatus. Supplemental trip data corresponding to the trip plan data is determined based at least in part on map data. A first travel plan is generated based at least in part on the trip plan data and supplemental trip data. A second travel plan is identified. The second travel plan is an existing travel plan or an expected travel plan that conflicts with the first travel plan. Based on a collaboration level corresponding to the first user and the second user, the first travel plan, and the second travel plan, a conflict-resolved travel plan that resolves the conflict between the first travel plan and the second travel plan is generated. The conflict-resolved travel plan is provided to a vehicle apparatus prior to the first user beginning the first trip.

### TECHNOLOGICAL FIELD

An example embodiment relates generally to travel plan generation. An example embodiment relates generally to resolving and/or avoiding conflicts between travel plans corresponding to multiple users. An example embodiment generally relates to reducing navigation processing delays at the beginning of trips.

### BACKGROUND

Generally, when a user plans a trip (e.g., to drive to an event, work, a store, to visit a friend, and/or the like) the user may add an indication of the trip to a digital calendar on their mobile device. For example, on Thursday, a user may create a digital calendar entry stating “Meet Jaime at X Coffee Shop” at 9 am on that Saturday. However, when the user gets in their vehicle on Saturday to drive to X Coffee Shop, there may be a delay in the beginning of the trip as the vehicle apparatus in the vehicle determines a route from the user's current location to X Coffee Shop. In another example, the user may discover Saturday morning that a second user is expecting to take the same vehicle for a different trip (e.g., to meet one of the second user's friends at Y Coffee Shop). This may result in one of the users having to cancel or reschedule their trip and inconveniencing anyone they were to meet. Thus, despite the information regarding the first user's trip being entered in the user's mobile device days prior to the beginning of the planned trip, the first user may experience a delay in the beginning of the trip due to the vehicle apparatus determining a route or needing to resolve a conflict with a second user's trip.

### BRIEF SUMMARY OF SOME EXAMPLE EMBODIMENTS

Various embodiments are directed to navigation using multiple user trip integration. An example embodiment provides a conflict-resolved multiple user travel plan for use of one or more vehicles by a group of users. For example, conflict between user trips may be resolved based on a collaboration plan comprising collaboration levels between pairs of users. An example embodiment generates a user behavior pattern database that may be used to anticipate potential conflicts between user trips, aid in avoiding and/or resolving conflict between user trips, and/or be used to adjust and/or control one or more systems of a vehicle (e.g., driver assistance system, safety system, mechanical system, ventilation system, entertainment system, and/or the like) based on user preferences. An example embodiment provides a planned route for a trip of the conflict-resolved multiple user travel plan prior to the beginning of the trip such that the beginning of the trip is not delayed by the processing time required to determine a route for the trip.

In an example embodiment, trip plan data is received from a user apparatus corresponding to a first trip to be taken by a first user. Supplemental trip data corresponding to the trip plan data is determined at least in part on map data. A first travel plan is generated based at least in part on the trip plan data and the supplemental trip data. A second travel plan is identified. The second travel plan is associated with a second user and conflicts with the first travel plan. The second travel plan may be an existing travel plan or an expected travel plan. Based on (a) a collaboration level corresponding to the first user and the second user, (b) the first travel plan, and (c) the second travel plan, a conflict-resolved travel plan is generated. The conflict-resolved travel plan resolves the conflict between the first travel plan and the second travel plan. The conflict-resolved travel plan is provided to a vehicle apparatus prior to the first user beginning the first trip.

In accordance with an example embodiment, a method is provided that comprises receiving trip plan data from a user apparatus corresponding to a first trip to be taken by a first user. The method further comprises determining supplemental trip data corresponding to the trip plan data based at least in part on map data and generating a first travel plan based at least in part on the trip plan data and the supplemental trip data. The method further comprises identifying a second travel plan associated with a second user, the second travel plan being an existing travel plan or an expected travel plan that conflicts with the first travel plan. The method further comprises, based on (a) a collaboration level corresponding to the first user and the second user, (b) the first travel plan, and (c) the second travel plan, generating a conflict-resolved travel plan that resolves the conflict between the first travel plan and the second travel plan. The method further comprises providing the conflict-resolved travel plan to a vehicle apparatus or the user apparatus prior to the first user beginning the first trip.

In an example embodiment, the conflict-resolved travel plan comprises a planned route for the first trip. In an example embodiment, the vehicle apparatus is configured to provide the planned route via a display of the vehicle apparatus. In an example embodiment, wherein the vehicle apparatus is configured to control one or more systems of a corresponding vehicle in accordance with the conflict-resolved travel plan. In an example embodiment, the conflict-resolved travel plan comprises user preferences for the first user, the user preferences determined based on a user behavior pattern database. In an example embodiment, the supplemental trip data comprises at least one of expected energy consumption of the first trip, vehicle diagnoses or prognosis information for a vehicle to be used for the first trip, vehicle maintenance information associated with the first trip, expected driving effort of the first trip, expected weather information corresponding to the first trip, expected travel time for the first trip, a planned route for the first trip, expected traffic information corresponding to the first trip, a planned beginning time of the first trip, or first user behavior pattern information. In an example embodiment, if the second travel plan is an existing travel plan, the second travel plan is determined based on second trip data received from a second user apparatus corresponding to the second user, and if the second travel plan is an expected travel plan, the second travel plan is determined based on a user behavior database. In an example embodiment, the collaboration level indicates a priority of a trip to be taken by the first user with respect to a trip to be taken by the second user. In an example embodiment, the collaboration level comprises a first set of features available to the first user corresponding to the second user. In an example embodiment, the method further comprises updating a user behavior database based on (a) the trip plan data, (b) the conflict-resolved travel plan, (c) user conflict resolution choices, or (d) a combination thereof. In an example embodiment, generating the conflict-resolved travel plan comprises at least one of: (i) requesting and receiving feedback from at least one of (a) the first user via the first user apparatus or (b) the second user via the second user apparatus, (ii) application of a collaboration level corresponding to the first user and the second user, and (iii) generating a combined trip that comprises the first trip and the second trip. In an example embodiment, the collaboration plan comprises vehicle preference information for at least one of the first user and the second user and the conflict-resolved travel plan comprises a vehicle assignment for at least one of the first trip or the second trip.

In accordance with an example embodiment, an apparatus is provided that comprises at least one processor, at least one memory storing computer program code, with the at least one memory and the computer program code configured to, with the processor, cause the apparatus to at least receive trip plan data from a user apparatus corresponding to a first trip to be taken by a first user. The at least one memory and the computer program code are further configured to, with the processor, cause the apparatus to determine supplemental trip data corresponding to the trip plan data based at least in part on map data and generate a first travel plan based at least in part on the trip plan data and the supplemental trip data. The at least one memory and the computer program code are further configured to, with the processor, cause the apparatus to identify a second travel plan associated with a second user, the second travel plan being an existing travel plan or an expected travel plan that conflicts with the first travel plan. The at least one memory and the computer program code are further configured to, with the processor, cause the apparatus to, based on (a) a collaboration level corresponding to the first user and the second user, (b) the first travel plan, and (c) the second travel plan, generate a conflict-resolved travel plan that resolves the conflict between the first travel plan and the second travel plan. The at least one memory and the computer program code are further configured to, with the processor, cause the apparatus to provide the conflict-resolved travel plan to a vehicle apparatus or the user apparatus prior to the first user beginning the first trip.

In an example embodiment, the conflict-resolved travel plan comprises a planned route for the first trip. In an example embodiment, the vehicle apparatus is configured to provide the planned route via a display of the vehicle apparatus. In an example embodiment, wherein the vehicle apparatus is configured to control one or more systems of a corresponding vehicle in accordance with the conflict-resolved travel plan. In an example embodiment, the conflict-resolved travel plan comprises user preferences for the first user, the user preferences determined based on a user behavior pattern database. In an example embodiment, the supplemental trip data comprises at least one of expected energy consumption of the first trip, vehicle diagnoses or prognosis information for a vehicle to be used for the first trip, vehicle maintenance information associated with the first trip, expected driving effort of the first trip, expected weather information corresponding to the first trip, expected travel time for the first trip, a planned route for the first trip, expected traffic information corresponding to the first trip, a planned beginning time of the first trip, or first user behavior pattern information. In an example embodiment, if the second travel plan is an existing travel plan, the second travel plan is determined based on second trip data received from a second user apparatus corresponding to the second user, and if the second travel plan is an expected travel plan, the second travel plan is determined based on a user behavior database. In an example embodiment, the collaboration level indicates a priority of a trip to be taken by the first user with respect to a trip to be taken by the second user. In an example embodiment, the collaboration level comprises a first set of features available to the first user corresponding to the second user. In an example embodiment, the at least one memory and the computer program code are further configured to, with the processor, cause the apparatus to update a user behavior database based on (a) the trip plan data, (b) the conflict-resolved travel plan, (c) user conflict resolution choices, or (d) a combination thereof. In an example embodiment, generating the conflict-resolved travel plan comprises at least one of: (i) requesting and receiving feedback from at least one of (a) the first user via the first user apparatus or (b) the second user via the second user apparatus, (ii) application of a collaboration level corresponding to the first user and the second user, and (iii) generating a combined trip that comprises the first trip and the second trip. In an example embodiment, the collaboration plan comprises vehicle preference information for at least one of the first user and the second user and the conflict-resolved travel plan comprises a vehicle assignment for at least one of the first trip or the second trip.

In accordance with an example embodiment, a computer program product is provided that comprises at least one non-transitory computer-readable storage medium having computer-executable program code instructions stored therein with the computer-executable program code instructions comprising program code instructions configured to receive trip plan data from a user apparatus corresponding to a first trip to be taken by a first user. The computer-executable program code instructions further comprise program code instructions configured to determine supplemental trip data corresponding to the trip plan data based at least in part on map data and generate a first travel plan based at least in part on the trip plan data and the supplemental trip data. The computer-executable program code instructions further comprise program code instructions configured to identify a second travel plan associated with a second user, the second travel plan being an existing travel plan or an expected travel plan that conflicts with the first travel plan. The computer-executable program code instructions further comprise program code instructions configured to, based on (a) a collaboration level corresponding to the first user and the second user, (b) the first travel plan, and (c) the second travel plan, generate a conflict-resolved travel plan that resolves the conflict between the first travel plan and the second travel plan. The computer-executable program code instructions further comprise program code instructions configured to provide the conflict-resolved travel plan to a vehicle apparatus or the user apparatus prior to the first user beginning the first trip.

In an example embodiment, the conflict-resolved travel plan comprises a planned route for the first trip. In an example embodiment, the vehicle apparatus is configured to provide the planned route via a display of the vehicle apparatus. In an example embodiment, wherein the vehicle apparatus is configured to control one or more systems of a corresponding vehicle in accordance with the conflict-resolved travel plan. In an example embodiment, the conflict-resolved travel plan comprises user preferences for the first user, the user preferences determined based on a user behavior pattern database. In an example embodiment, the supplemental trip data comprises at least one of expected energy consumption of the first trip, vehicle diagnoses or prognosis information for a vehicle to be used for the first trip, vehicle maintenance information associated with the first trip, expected driving effort of the first trip, expected weather information corresponding to the first trip, expected travel time for the first trip, a planned route for the first trip, expected traffic information corresponding to the first trip, a planned beginning time of the first trip, or first user behavior pattern information. In an example embodiment, if the second travel plan is an existing travel plan, the second travel plan is determined based on second trip data received from a second user apparatus corresponding to the second user, and if the second travel plan is an expected travel plan, the second travel plan is determined based on a user behavior database. In an example embodiment, the collaboration level indicates a priority of a trip to be taken by the first user with respect to a trip to be taken by the second user. In an example embodiment, the collaboration level comprises a first set of features available to the first user corresponding to the second user. In an example embodiment, the computer-executable program code instructions further comprise program code instructions configured to update a user behavior database based on (a) the trip plan data, (b) the conflict-resolved travel plan, (c) user conflict resolution choices, or (d) a combination thereof. In an example embodiment, generating the conflict-resolved travel plan comprises at least one of: (i) requesting and receiving feedback from at least one of (a) the first user via the first user apparatus or (b) the second user via the second user apparatus, (ii) application of a collaboration level corresponding to the first user and the second user, and (iii) generating a combined trip that comprises the first trip and the second trip. In an example embodiment, the collaboration plan comprises vehicle preference information for at least one of the first user and the second user and the conflict-resolved travel plan comprises a vehicle assignment for at least one of the first trip or the second trip.

In accordance with yet another example embodiment of the present invention, an apparatus is provided that comprises means for receiving trip plan data from a user apparatus corresponding to a first trip to be taken by a first user. The apparatus comprises means for determining supplemental trip data corresponding to the trip plan data based at least in part on map data. The apparatus comprises means for generating a first travel plan based at least in part on the trip plan data and the supplemental trip data; The apparatus comprises means for identifying a second travel plan associated with a second user, the second travel plan being an existing travel plan or an expected travel plan that conflicts with the first travel plan. The apparatus comprises means for based on (a) a collaboration level corresponding to the first user and the second user, (b) the first travel plan, and (c) the second travel plan, generating a conflict-resolved travel plan that resolves the conflict between the first travel plan and the second travel plan. The apparatus comprises means for providing the conflict-resolved travel plan to a vehicle apparatus prior to the first user beginning the first trip.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example architecture of one embodiment of the present invention;

FIG. 2A is a block diagram of an integration apparatus that may be specifically configured in accordance with an example embodiment;

FIG. 2B is a block diagram of a user apparatus that may be specifically configured in accordance with an example embodiment;

FIG. 2C is a block diagram of a vehicle apparatus that may be specifically configured in accordance with an example embodiment;

FIG. 3 is a diagram illustrating a data flow, in accordance with an example embodiment;

FIG. 3A is a diagram illustrating the data flow used to generate a collaboration plan, in accordance with an example embodiment;

FIG. 4 is a flowchart illustrating operations performed, such as by the user apparatus of FIG. 2B to determine a traffic state of a vehicle, in accordance with an example embodiment;

FIG. 5 is a flowchart illustrating operations performed, such as by the integration apparatus of FIG. 2A to determine a traffic state of a vehicle, in accordance with an example embodiment; and

FIG. 6 is a flowchart illustrating operations performed, such as by the vehicle apparatus of FIG. 2C to determine a traffic state of a vehicle, in accordance with an example embodiment.

### DETAILED DESCRIPTION OF SOME EXAMPLE EMBODIMENTS

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

### I. General Overview

Methods, apparatus and computer program products are provided in accordance with an example embodiment in order to determine and/or generate a conflict-resolved travel plan for multiple users. In an example embodiment, the conflict-resolved travel plan may be provided to a vehicle apparatus onboard a vehicle to be driven for one or more trips of the conflict-resolved travel plan. In an example embodiment, the vehicle apparatus may then provide a route for a trip of the one or more trips at the beginning of the corresponding trip without processing delays. In an example embodiment, the vehicle apparatus may operate and/or adjust one or more systems of the vehicle based on user preferences of the user taking the trip based on the conflict-resolved travel plan. In an example embodiment, the conflict-resolved travel plan may be generated based on instances of trip plan information/data entered by one or more users of the multiple users to their respective mobile devices (e.g., mobile phones and/or the like), a collaboration plan for the multiple users, user behavior patterns, supplemental trip information/data (e.g., expected energy usage, expected traffic information/data, expected weather information/data, a planned route, planned trip beginning time, and/or the like), and/or other information/data.

For example, an application executing on a user apparatus may identify new trip plans and/or modifications of existing trip plans. For example, the application may interface with a digital calendar on the user apparatus, scrape the user's text message, emails, instant messages, and/or the like, or otherwise harvest or receive trip plan information/data from the user apparatus and/or applications operating thereon and/or interfacing therewith. The new or modified trip plan information/data is provided (e.g., transmitted) to an integration apparatus. The integration apparatus may determine and/or request and receive supplemental trip information/data. For example, the integration apparatus may interface with a vehicle apparatus onboard the vehicle to be driven and/or used for the trip corresponding to the trip plan information/data to determine maintenance needed (e.g., an oil change, a brake light replaced, refueling or battery recharging, and/or the like) prior to, during, and/or directly after the trip. In another example, the integration apparatus may determine a planned route for the trip, expected traffic information/data for the trip (e.g., based on historical traffic information/data), an expected energy consumption (e.g., gasoline, diesel, electric battery depletion) for the trip, and/or the like. In another example, the integration apparatus may communicate with one or more external and/or remote apparatuses to determine, for example, expected weather information/data for the trip. Based on the trip plan information/data received from the user apparatus and the supplemental trip information/data, the integration apparatus may determine and/or generate a first travel plan for the trip. The first travel plan may comprise, for example, a planned trip beginning time, a planned route, instructions regarding vehicle maintenance, and/or the like. The integration apparatus may then determine if any other travel plans corresponding to the vehicle to be driven and/or used for the trip conflict with the first travel plan. If no conflicting travel plans are identified, a conflict-resolved travel plan is generated based on the first travel plan. If a conflicting travel plan is identified, the conflict may be resolved through user interaction, application of a collaboration plan, and/or the like. In an example embodiment, a conflicting travel plan may be an existing travel plan or an expected travel plan (e.g., based on a stored user behavior pattern). A conflict-resolved travel plan may then be determined and/or generated. The conflict-resolved travel plan may be provided to the user apparatus so that relevant information/data of the conflict-resolved travel plan may be provided (e.g., displayed and/or audibly provided) to the user at an appropriate time. The conflict-resolved travel plan may also be provided to a vehicle apparatus onboard and/or associated with the corresponding vehicle.

In an example embodiment, a vehicle apparatus may receive a conflict-resolved travel plan. When a user enters and/or turns on the corresponding vehicle at a time that is approximately the planned trip beginning time of the conflict-resolved travel plan (e.g., within 10 minutes, 5 minutes, or 1 minutes of the planned trip beginning time), the vehicle apparatus may determine that the user is beginning the trip of the conflict resolved travel plan. The vehicle apparatus may then access the planned route for the trip, the user preferences, expected weather information/data, expected traffic information/data from the locally stored and/or accessible conflict-resolved travel plan. The vehicle apparatus may then provide a route for the trip in real time or near real time with the user entering and/or turning on the vehicle, in an example embodiment. The vehicle apparatus may control one or more systems of the vehicle based on the user preferences, expected weather information/data, expected traffic information/data, the planned route and/or the like.

Thus, example embodiments may prevent and resolve conflict between multiple users planning trips that use the same vehicle or vehicles from a set of vehicles. Example embodiments provide benefits such as reducing delay at the beginning of a trip due to a user needing to enter trip plan information/data (e.g., a destination) at the beginning of the trip and a route for the trip needing to be determined. Additionally, example embodiments, provide the advantage of real time or near real time re-evaluation of a conflict-resolved travel plan such that unexpected delays in a first trip are identified in real time or near real time and the effects on a second trip may be mitigated. Example embodiments provide further advantages such as the automatic controlling and/or modification of one or more systems of the vehicle based on user behavior patterns and other aspects of the conflict-resolved travel plan. Example embodiments further provide an optimized use of a vehicle's fuel/energy supply in view of future and/or expected vehicle use. For example, example embodiments may reduce untimely refueling and/or recharging of a vehicle and provide efficient energy management of the vehicle's fuel/energy resources.

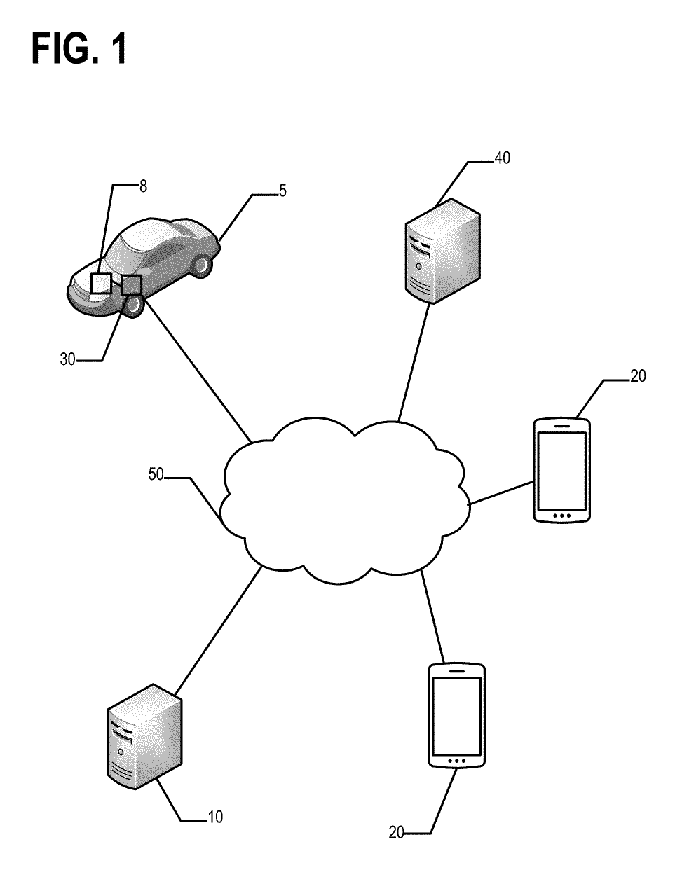

FIG. 1 provides an illustration of an example system that can be used in conjunction with various embodiments of the present invention. As shown in FIG. 1, the system may include one or more integration apparatuses 10, a plurality of user apparatuses 20, one or more vehicle apparatuses 30, wherein each vehicle apparatus 30 is disposed on a vehicle 5, one or more other computing entities 40, one or more networks 50, and/or the like. In various embodiments, the vehicle apparatus 30 may be an in vehicle navigation system, vehicle control system, a mobile computing device, and/or the like. For example, a vehicle apparatus 30 may be an in vehicle navigation system mounted within and/or be onboard a vehicle 5 such as a motor vehicle, non-motor vehicle, automobile, car, scooter, truck, van, bus, motorcycle, bicycle, Segway, golf cart, and/or the like. In an example embodiment, the vehicle apparatus 30 may be a vehicle control system configured to autonomously drive a vehicle 5, assist in control of a vehicle 5, monitor various aspects of the vehicle 5 (e.g., fault conditions, motor oil status, battery charge level, fuel tank fill level, and/or the like) and/or the like. In an example embodiment, the vehicle apparatus 30 may be configured to control and/or adjust one or more systems 8 of the vehicle 5 (e.g., driver assistance or safety systems). In some embodiments, a vehicle apparatus 30 may be onboard a personal vehicle, commercial vehicle, public transportation vehicle, fleet vehicle, and/or other vehicle. In various embodiments, the user apparatus 20 may be a smartphone, tablet, personal digital assistant (PDA), personal computer, desktop computer, laptop, and/or other mobile computing device. In an example embodiment, the integration apparatus 10 may be a server, group of servers, distributed computing system, and/or other computing system. For example, the integration apparatus 10 may comprise and/or be in communication with one or more data mining engines, one or more navigation engines, one or more user behavior pattern databases, one or more conflict resolution engines, and/or the like.

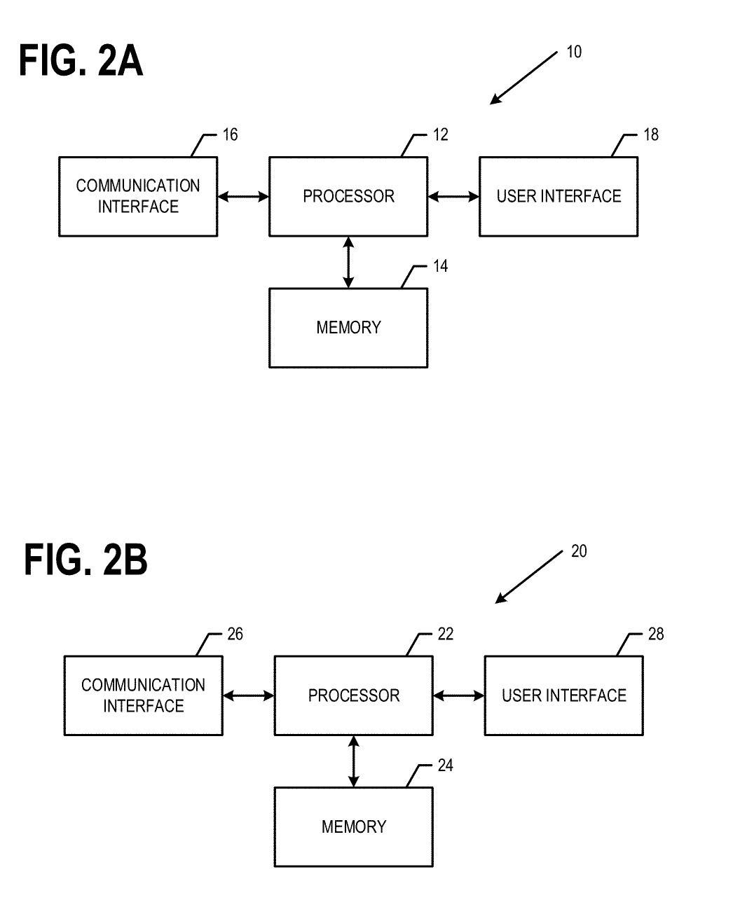

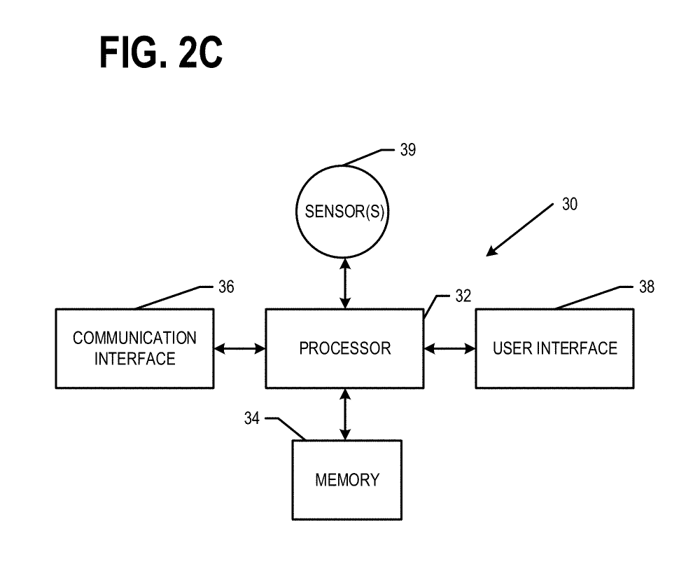

In an example embodiment, an integration apparatus 10 may comprise components similar to those shown in the example remote apparatus 10 diagrammed in FIG. 2A. In an example embodiment, the integration apparatus 10 is configured to receive trip plan information/data from the plurality of user apparatuses 20, weather and/or traffic information/data from one or more other computing entities 40, vehicle information/data from the vehicle apparatus 30, and/or the like. The integration apparatus 10 may be configured to generate, store, manage, and/or the like a user behavior pattern database based on user information/data received from the user apparatuses 20 and/or the vehicle apparatuses 30, information/data (e.g., weather information/data, traffic information/data, and/or the like) received from another computing entity 40, and/or determined by the integration apparatus 10. The integration apparatus 10 may be further configured to generate one or more conflict-resolved travel plans based on the trip information/data received from the user apparatuses 20, a collaboration plan for the group of users corresponding to the one or more user apparatuses 20, supplemental information/data determined and/or requested and received by the integration apparatus 10, and/or the like. A conflict-resolved travel plan may comprise a destination, timing information/data (e.g., a planned beginning time, a travel time, an expected arrival time, and/or the like), a planned route, energy requirement information/data, and/or the like. For example, as shown in FIG. 2A, the integration apparatus 10 may comprise a processor 12, memory 14, a user interface 18, a communications interface 16, and/or other components configured to perform various operations, procedures, functions or the like described herein. In at least some example embodiments, the memory 14 is non-transitory.

In an example embodiment, a user apparatus 20 may comprise components similar to those shown in the example user apparatus 20 diagrammed in FIG. 2B. In an example embodiment, a user apparatus 20 may be configured to receive user input and/or otherwise receive trip plan information/data (e.g., extract, scrape and/or the like from user emails, text messages, instant messages, voicemail, digital calendar, and/or the like), provide the trip plan information/data to the integration apparatus 10, receive conflict-resolved travel plans from the integration apparatus 10, and provide at least a portion of the conflict-resolved travel plan to a user. For example, the user apparatus 20 may operate a client module, program, application, and/or the like, configured to identify trip plan information/data entered in (e.g., via user input to a user interface) and/or received by, for example, a user's digital calendar, trip planning application, and/or the like. In an example embodiment, the client module, program, application, and/or the like may be configured to identify trip plan information/data within text messages (e.g., short message service (SMS) or multimedia message service (MMS) message), an e-mail, instant message, voicemail, and/or the like stored by and/or accessed by the user apparatus 20. For example, the client module, program, application and/or the like may comprise one or more application programming interfaces (APIs) configured to interface with, scrape, and/or the like various other applications, programs, modules, and/or the like operating on the user apparatus 20. The identified trip plan information/data may be extracted, parsed, and/or the like by the client module, program, application, and/or the like and provided to the integration apparatus 10. The client module, program, application, and/or the like may be further configured to receive conflict-resolved trip information/data from the integration apparatus 10 and update, for example, a user's digital calendar or trip planning application accordingly. The user apparatus may further provide the user with the planned route, one or more reminders regarding the planned trip beginning time, and/or the like. In an example embodiment, as shown in FIG. 2B, the user apparatus 20 may comprise a processor 22, memory 24, a communications interface 26, a user interface 28, and/or other components configured to perform various operations, procedures, functions or the like described herein. In at least some example embodiments, the memory 24 is non-transitory.

In an example embodiment, a vehicle apparatus 30 is onboard a vehicle 5. The vehicle apparatus 30 may be in communication with one or more systems 8 of the vehicle 5. For example, the vehicle comprises one or more systems 8 (e.g., mechanical and/or other systems) configured to control and/or assist the movement of the vehicle 5 along a route, aid in passenger and driver comfort, and/or the like. For example, the one or more systems 8 may comprise one or more driver assistance or safety systems. The driver assistance systems are systems that make operation of the vehicle safer or more convenient. The driver assistance systems may include an obstacle warning system, a lane departure warning system, an adaptive cruise control system, a collision avoidance system, and/or the like. The driver assistance systems may include other systems in addition to, or instead of, any of these systems. In an example embodiment, the one or more systems 8 may be configured to autonomously drive the vehicle 5, assist in driving the vehicle 5, provide timely warnings to a driver of the vehicle 5, and/or the like. In an example embodiment, the one or more mechanical systems may be controlled, at least in part by the vehicle apparatus 30. In an example embodiment, the vehicle apparatus 30 may be further configured to provide navigation and/or route information/data to a user (e.g., an operator of the vehicle 5). In an example embodiment, the vehicle apparatus 30 may be configured to autonomously drive a vehicle 5 and/or assist in control of a vehicle 5 in accordance with navigation and/or route information. For example, the vehicle apparatus 30 may be in communication with the fuel system of the vehicle 5. For example, the vehicle apparatus 30 may be configured, programmed, and/or the like to determine a current fuel level of the vehicle 5. In various embodiments, the fuel level may correspond to an amount of gasoline, an amount of diesel fuel, an electric battery charge level, and/or other fuel level appropriate for the vehicle 5. In another example, the vehicle apparatus 30 may be configured to control a radio or entertainment system, a seat positioning system, and/or other system of the vehicle 5.

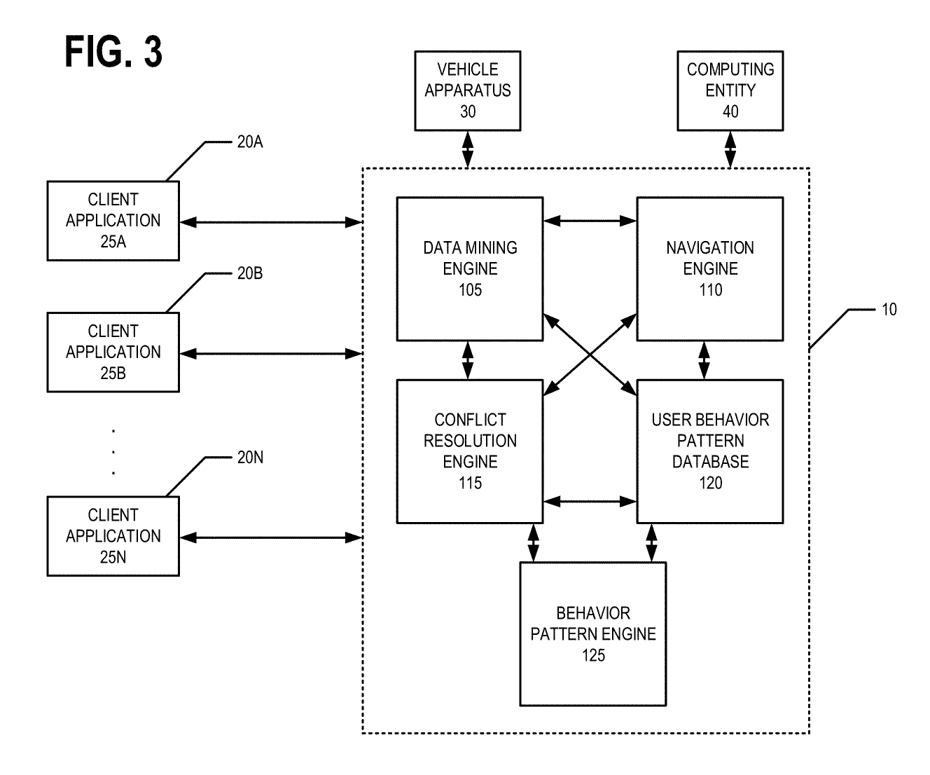

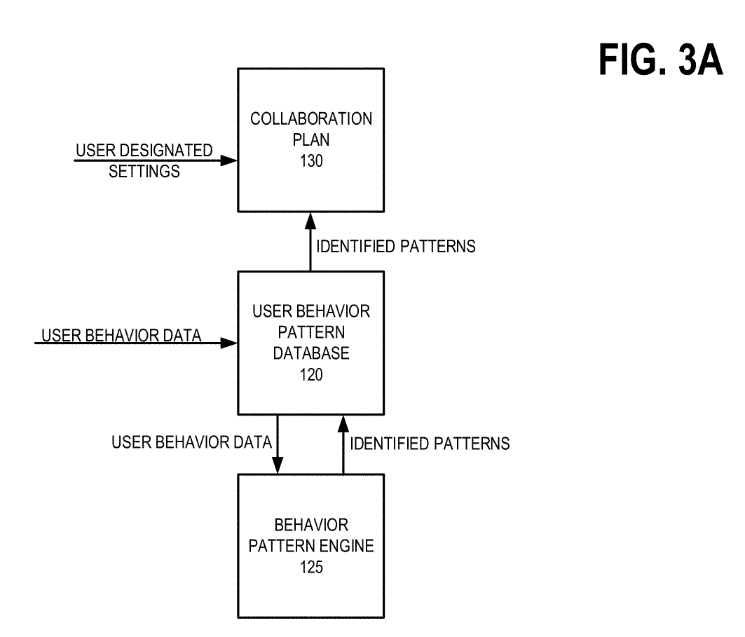

In various embodiments, the navigation and/or route information/data may be generated, determined, and/or the like by the vehicle apparatus 30 and/or received from an integration apparatus 10 (e.g., generated, determined, and/or the like by the navigation engine 110 shown in FIG. 3). In an example embodiment, as shown in FIG. 2C, the vehicle apparatus 30 may comprise a processor 32, memory 34, a communications interface 36, a user interface 38, one or more sensors 39 (e.g., a location sensor such as a GNSS sensor; IMU sensors; camera(s); two dimensional (2D) and/or three dimensional (3D) light detection and ranging (LiDAR)(s); long, medium, and/or short range radio detection and ranging (RADAR); ultrasonic sensors; electromagnetic sensors; (near-) infrared (IR) cameras; 3D cameras; 360° cameras; fuel level sensors; vehicle system sensors (e.g., oil status sensors, tire pressure sensors, engine oil pressure sensors, coolant level sensors, engine/coolant temperature sensors, and/or other sensors that enable the vehicle apparatus 30 to determine one or more features of the corresponding vehicle's 5 surroundings and/or monitor the vehicle's 5 operating parameters), and/or other components configured to perform various operations, procedures, functions or the like described herein. In at least some example embodiments, the memory 34 is non-transitory.

In an example embodiment, the integration apparatus 10, user apparatus 20, and/or vehicle apparatus 30 may be in communication with one or more other computing entities 40. For example, weather information/data may be received from a computing entity 40 that corresponds to and/or is part of a weather station or weather station monitoring system; traffic information/data may be received from a computing entity 40 that is part of a traffic monitoring system. In an example embodiment, a computing entity 40 may comprise similar elements to the integration apparatus 10, user apparatus 20, and/or the vehicle apparatus 30. For example, the computing entity 40 may comprise a processor, memory, a user interface, a communications interface, and/or the like. In an example embodiment, the computing entity 40 may comprise one or more sensors similar to sensor(s) 39.

Each of the components of the system may be in electronic communication with, for example, one another over the same or different wireless or wired networks 50 including, for example, a wired or wireless Personal Area Network (PAN), Local Area Network (LAN), Metropolitan Area Network (MAN), Wide Area Network (WAN), cellular network, and/or the like. In some embodiments, a network 50 may comprise the automotive cloud, digital transportation infrastructure (DTI), radio data system (RDS)/high definition (HD) radio or other digital radio system, and/or the like. For example, a vehicle apparatus 30 and/or a plurality of user apparatuses 20 may be in communication with an integration apparatus 10 via the network 50. For example, a vehicle apparatus 30 and/or a user apparatus 20 may communicate with the integration apparatus 10 via a network, such as the Cloud. For example, the Cloud may be a computer network that provides shared computer processing resources and data to computers and other devices connected thereto. For example, the vehicle apparatus 30 may be configured to receive one or more map tiles of a digital map from the integration apparatus 10 or another map service connected via the network 50, traffic information/data (embedded in a map tile of a digital map and/or separate therefrom), receive one or more conflict-resolved trip plans from the integration apparatus 10, and/or provide vehicle information/data to the integration apparatus 10.

Certain example embodiments of the vehicle apparatus 30, user apparatus 20, and the integration apparatus 10 are described in more detail below with respect to FIGS. 2A, 2B, and 2C.

### II. Example Operation

Example embodiments provide methods, apparatus, systems, computer program products, and/or the like for generating a conflict-resolved travel plan and providing the conflict-resolved travel plan to a vehicle apparatus 30 before the planned trip beginning time of a trip in the conflict-resolved travel plan.

FIG. 3 provides a schematic diagram of a data flow in an example embodiment. In an example embodiment, the conflict-resolved travel plan corresponds to a group of users. In an example embodiment, the group of users comprises N users (e.g., a first user, a second user, . . . , and an Nth user). Each user of the group of users may be associated with a user apparatus 20. For example, the first user apparatus 20 may be associated with the first user and be the first user's mobile phone, PDA, tablet, laptop, desktop computer, and/or the like. In an example embodiment, the conflict-resolved travel plan corresponds to a set of M vehicles (e.g., a first vehicle, a second vehicle, an Mth vehicle). In an example embodiment, the group of users is a family and the set of M vehicles is a single vehicle or a first and second vehicle, and/or the like. In an example embodiment, the group of users are members of a car share program, users of a motor pool of company owned vehicles, and/or the like. Thus, in some embodiments the set of M vehicles is a fleet of vehicles.

In an example embodiment, each user apparatus 20 (e.g., 20A, 20B, . . . , 20N) executes a client application, module, program and/or the like (referred to herein as client application 25 (e.g., 25A, 25B, 25N)). The client application 25 is configured to interface with, scrape, and/or the like one or more other applications executing on the corresponding user apparatus 20 to identify and extract instances of trip plan information/data. In an example embodiment, trip plan information/data may comprise a date, a planned arrival time or an arrive by time, a destination, and/or the like. In an example embodiment, the trip plan information/data may comprise an indication of which vehicle of the set of vehicles or a vehicle type that is preferred for the trip. For example, if the trip is a family or group trip (e.g., one or more children and/or a plurality of adults are going to be transported as part of the trip) the user may desire to use a larger vehicle such as a mini-van, station wagon, sport utility vehicle, full-sized sedan, and/or the like. Thus, for example, if the trip plan is information/data is extracted from a digital calendar entry and an invite was sent to multiple other users, it may be determined that a larger vehicle may be desired for the trip. In another example, if the trip is a work commute, the user may desire to use a compact sedan and/or other small car.

After and/or in response to identifying and extracting trip plan information/data, the client application 25 may provide (e.g., transmit) the trip plan information/data to a data mining engine 105 that is operated by and/or in communication with an integration apparatus 10. The data mining engine 105 may determine supplemental trip, information/data, request and receive supplemental trip information/data, request and receive information/data that is used to determine supplemental trip information/data, and/or the like. For example, the data mining engine 105 may request vehicle information/data from the vehicle apparatus 30. In an example embodiment, vehicle information/data may comprise a current or expected fault condition of the vehicle 5 and/or one or more systems 8, a current fuel level or battery charge level of the vehicle 5, required and/or suggested maintenance information/data for the vehicle 5 and/or one or more systems 8, and/or the like. For example, the data mining engine 105 may request weather information/data, traffic information/data, and/or the like from one or more other computing entities 40. In an example embodiment, the data mining engine 105 may request an expected travel time, a planned route, and/or the like from the navigation engine 110. In an example embodiment, the data mining engine 105 may request user behavior pattern information/data (e.g., user preferences, user driving style, user timeliness, and/or other identified patterns in user behavior) from the user behavior pattern database 120.

The data mining engine 105 may then determine, generate, and/or the like a first travel plan based on the trip plan information/data and the supplemental trip information/data. The first travel plan may comprise first travel plan information/data. In an example embodiment, the first travel plan information/data may comprise at least a portion of the trip plan information/data (e.g., a destination, planned arrival time and/or arrive by time, date, preferred vehicle or vehicle type, and/or the like), at least a portion of the received supplemental trip information/data (e.g., planned route; expected travel time; expected traffic and/or weather information/data; expected, suggested, and or required maintenance; relevant user behavior pattern information/data; and/or the like), and determined supplemental trip information/data (e.g., a planned trip beginning time, fuel/energy requirements for the trip, expected driving effort of the trip, and/or the like).

The conflict resolution engine 115 may receive the first travel plan from the data mining engine 105 and determine if any other travel plans conflict with the first travel plan. A second travel plan conflicts with the first travel plan if the first and second travel plans correspond to the same vehicle and the corresponding trips overlap in time, if maintenance would need to be performed between the corresponding trips but there will not be sufficient time to perform the maintenance (e.g., if the electric battery would need to be recharged and there is not sufficient time between the expected end time of one trip and the planned trip beginning time of the other trip), and/or the like. In an example embodiment, the integration apparatus 10 may store a previously determined and/or generated conflict-resolved travel plan comprising any number of second travel plans. Each second travel plan comprises previously determined and/or generated travel plan information/data corresponding to an existing and/or previously planned trip. The conflict resolution engine 115 may determine if the first travel plan conflicts with any of the second travel plans.

In an example embodiment, the second travel plans of the previously determined and/or generated conflict-resolved travel plan may take into account user behavior patterns (e.g., as identified by the behavior pattern engine 125 as shown in FIG. 3A). For example, a first user may usually finish a trip as expected and a second user may usually finish a trip approximately 10-15 minutes later than expected (e.g., due to driving habits, and/or for other reasons). Any second plan corresponding to the second user may take into account the second user's usual 10-15 minute tardiness such that the second user arriving late from completing a trip will not cause a conflict with a first user's trip. For example, the conflict-resolved travel plan may take into account user behavior patterns (e.g., as identified by the behavior pattern engine 125 and/or stored in the user behavior pattern database 120) to avoid potential conflicts caused by user behavior (e.g., arriving late, unwillingness to share the vehicle, and/or the like). Therefore, even if it would appear that a first travel plan does not conflict with a second travel plan if the second travel plan was completed as scheduled, if it is known that the second user corresponding to the second travel plan often arrives several minutes late and this late arrival would cause a conflict between the first travel plan and the second travel plan, this conflict may be anticipated and avoided.

In an example embodiment, the integration apparatus 10 may comprise and/or be in communication with a user behavior pattern database 120. The user behavior pattern database 120 may store user behavior pattern information/data corresponding to the N users of the group. The user behavior pattern information/data may comprise a template travel plan for a trip that is usually taken by a particular user. For example, if the second user generally takes a first vehicle to the grocery store at 10 am on Thursday, the user behavior pattern information/data may comprise a template travel plan corresponding to a trip taken at 10 am on Thursday with the first vehicle with the destination being the grocery store located at 254 First Ave. For example, the client application 25B operating on the second user apparatus 20, the vehicle apparatus 30 onboard the first vehicle 5, and/or the integration apparatus 10 may determine, learn, and/or recognize a pattern of the second user taking a trip to the same location at generally the same time on the same day of the week. For example, the integration apparatus 10 may comprise a behavior pattern engine 125 configured and/or programmed to analyze the user behavior information/data (e.g., stored in the user behavior database 120) and identify patterns within the user behavior data information/data. The behavior pattern engine 125 may then generate a template travel plan corresponding to the regularly taken trip and cause the template travel plan to be stored by the user behavior pattern database 120 in association with the second user. In an example embodiment, a template travel plan may be weather dependent and/or depend on various other information/data (e.g., traffic information/data). For example, the behavior pattern engine 125 may determine and/or identify that the second user only takes the trip corresponding to the template travel plan under certain weather conditions (e.g., the second user travels to a particular beach on Saturday afternoons if the weather is nice). It may then be determined if the first travel plan conflicts with any of the template travel plans stored in the user behavior pattern database 120. Thus, it may be determined if the first travel plan conflicts with any existing, previously planned travel plans and/or with any expected travel plans represented by travel plan templates, in an example embodiment.

If it is determined (e.g., by the integration apparatus 10) that the first travel plan does not conflict with any existing, previously planned travel plans or any expected travel plans (e.g., template travel plans), then a current conflict-resolved travel plan may be determined, generated, and/or the like that comprises the first travel plan the second travel plans of the previously determined and/or generated conflict-resolved travel plan. The current conflict-resolved travel plan may be stored by the integration apparatus 10 (e.g., in memory 14) and provided (e.g., transmitted) to one or more user apparatuses 20 (e.g., provided to the corresponding client application 25) and/or one or more vehicle apparatuses 30.

If it is determined (e.g., by the integration apparatus 10) that the first travel plan conflicts with a template travel plan associated with a second user, the integration apparatus 10 may provide a feedback request to the second user apparatus 20 (e.g., via the client application 25B) corresponding to the second user, in an example embodiment. For example, the request for feedback may include an inquiry asking if the second user is planning to take a trip corresponding to the template travel plan on the date corresponding to the first travel plan. The user apparatus 20 may provide the feedback request to the user (e.g., via the user interface 28) and receive feedback indicating a user-selected response to the feedback request (e.g., via the user interface 28). The feedback may indicate that the second user is planning to take a trip corresponding to the template travel plan, that the second user is not planning to take a trip corresponding to the template travel plan, that the second user will take a modified trip corresponding to the template travel plan (e.g., will take the trip on a different day of the week, will take the trip at a different time on the same day, will take the trip but will go to a different grocery store, and/or the like). The user apparatus 20 may provide an indication of the user-selected response to the integration apparatus 10. The conflict-resolution engine 115 may then determine if the conflict has been resolved and/or avoided. For example, if the user-selected response indicates that the user will not take the trip or will take a modified trip that avoids the conflict, then the conflict has been resolved and/or avoided. If the user indicates that the user wants to take the trip in accordance with the template travel plan, then the conflict has not been resolved and/or avoided. In an example embodiment, an indication of the user-selected response may be stored in the user behavior pattern database 120 for use in future conflict resolution. And the conflict resolution engine 115 will resolve the conflict based on a collaboration plan stored in the memory 14 and/or otherwise accessible to the integration apparatus 10, as will be described in more detail below.

If the first travel plan corresponding to the first user conflicts with an existing, previously planned travel plan corresponding to the second user, the conflict resolution engine 115 may provide (e.g., transmit) a feedback request to the first user apparatus 20A (e.g., the client application 25A) corresponding to the first user and/or provide (e.g., transmit) a feedback request to the second user apparatus 20B (e.g., the client application 25B) corresponding to the second user, in an example embodiment. For example, a feedback request provided to the first user may ask if the first user is willing to proactively modify their trip plans. Similarly, a feedback request provided to the second user may ask if the second user is willing to proactively modify their trip plans. The user apparatuses 20A, 20B may provide the feedback request (e.g., via a user interface 28) and receive feedback indicating a user-selected response to the feedback request (e.g., via the user interface 28). The user apparatuses 20A, 20B may then provide an indication of the user-selected response to the integration apparatus 10. The conflict-resolution engine 115 may then determine if the conflict has been resolved and/or avoided. If one or both of the users provided feedback indicating a willingness and/or desire to modify their trip, then the conflicts resolution engine 115 (e.g., operating on the integration apparatus 10) may determine that the conflict has been resolved and/or avoided. If neither of the users provide feedback indicating a willingness and/or desire to modify their trip, then the conflicts resolution engine 115 (e.g., operating on the integration apparatus 10), may determine that the conflict has not been resolved and/or avoided. In an example embodiment, an indication of the user-selected response may be stored in the user behavior pattern database 120 for use in future conflict resolution. The conflict resolution engine 115 may then resolve the conflict based on a collaboration plan stored in the memory 14 and/or otherwise accessible to the integration apparatus 10. In an example embodiment, the conflict resolution engine 115 may resolve the conflict between the first and second travel plans based on the collaboration plan and user behavior pattern information/data accessed from the user behavior pattern database 120.

In an example embodiment, a collaboration plan comprises a collaboration level for each pair of users. For example, if the group of users comprises three users (e.g., a first user, second user, and third user), the collaboration plan 130 (shown in FIG. 3A) comprises a collaboration level corresponding to the first user and the second user, a collaboration level corresponding to the first user and the third user, and a collaboration level corresponding to the second user and the third user. In an example embodiment, the collaboration level may indicate a priority level with regard to the corresponding users. Continuing with the example of a group with three users, in an example embodiment, the collaboration plan may comprise the following collaboration levels: the first user has priority over the second user, the third user has priority over the second user, and the first user has priority over the third user. In another example embodiment, a collaboration level may be a set of functions provided through the client application 25 and/or the integration apparatus 10. For example, the first user may be able to review and allow or reject travel plans corresponding to the second user, the first user may be able to manage travel plans corresponding to the second user, the first user may be notified of travel plans corresponding to the second user, the first user may be able to review travel plans corresponding to the second user that meet certain criteria (e.g., require fueling/charging of the vehicle, longer than a particular travel time, longer than a particular distance, corresponding to a particular vehicle of the set of vehicles), the first user can set collaboration levels for the second user regarding other users (e.g., the third user), and/or the like. In an example embodiment, the collaboration level corresponding to the first user and the second user may indicate the willingness of the first user to modify their travel plans to accommodate a travel plan of the second user and/or willingness to carpool with the second user (e.g., conditions under which the first user is willing to carpool with the second user) to accommodate both the first user's travel plan and the second user's travel plan. For example, the first user may be willing to begin their trip up to a predetermined amount of time earlier than the planned trip beginning time to accommodate sharing a vehicle with the second user so that the first and second users may be able to timely complete their respective trips. In another example, a collaboration plan 130 and/or user feedback (e.g., comprising user conflict resolution choices) may indicate a first or second user is willing to go to an alternative equivalent destination (e.g., a different grocery store, different coffee shop, and/or the like) so as to accommodate sharing a vehicle and/or completing a trip at a time that accommodates another trip. In another example, the collaboration plan 130 and/or user feedback may indicate that the first user and/or second user is willing to pick up and/or drop off the vehicle at an alternate destination. In another example, the collaboration plan 130 and/or user feedback may indicate that the first user and/or second user is willing to run an errand for the other user, which may prevent the other user from needing to take a trip. For example, the first user may be willing to drop off a load at the dry cleaner such that the second user's trip to the dry cleaner is not necessary. In an example embodiment, the collaboration level corresponding to a first user and a second user may indicate that the first user has priority over the second user for use of a first vehicle and the second user has priority over the first user for use of a second vehicle, and/or the like. Thus, the collaboration plan comprises collaboration levels corresponding to pairs of users that indicate priority, functions, and/or other information/data regarding how conflicts between the travel plans corresponding to the pair of users should be resolved.

In an example embodiment, as illustrated in FIG. 3A, the collaboration plan 130, one or more collaboration levels, and/or one or more aspects of one or more collaboration levels may be set through user input. For example, a user may provide input (e.g., via a user interface 28 of a user apparatus 20) setting and/or designating one or more collaborations levels and/or one or more aspects thereof. For example, one or more users may provide input (e.g., via the user interface 28 of a respective user apparatus 20) to provide an indication, selection, and/or the like of user set rules such as priorities and other discrete choices. For example, a first user may provide input via the user interface 28 of a first user apparatus 20A indicating, setting, defining, designating, and/or the like, that the first user always has priority over a third user, and has priority over a second user with respect to a first vehicle of the set of M vehicles. These user defined priorities may be used to establish and/or define the collaboration levels between the first user and the second and third users. Thus, in an example embodiment, one or more aspects of a collaboration plan 130 may be defined via user input. In an example embodiment, the collaboration plan 130, one or more collaboration levels, and/or one or more aspects of one or more collaboration levels may be set based on user behavior pattern information/data. For example, previous conflict resolution strategies (e.g., based on user feedback and/or the like) may be reused and/or incorporated into the collaboration plan 130. For example, if the behavior pattern engine 125 determines that when a travel plan for a first user conflicts with an existing, previously planned travel plan and/or a template travel plan corresponding to the second user, the second user always cancels or modifies their trip. The behavior pattern engine 125 may determine based thereon that the first user has priority over the second user, for example. In another example, the behavior pattern engine 125 may determine that the second user always finishes their trips approximately 10 minutes later than anticipated. The collaboration plan 130 may be updated based on the identified pattern of the second user generally finishing their trips 10 minutes late such that second user's tardiness is taken into account when resolving conflicts. Thus, at least one or more aspects of a collaboration plan 130 may be defined based on identified patterns based on user behavior pattern information/data stored in the user behavior pattern database 120.

Based on the collaboration plan 130, the integration apparatus 10 may determine a conflict resolution plan. For example, if the first travel plan corresponds to the first user, a second travel plan that conflicts with the first travel plan corresponds to the second user, and the collaboration level between the first user and the second user indicates that the first user has priority over the second user, a feedback request may be provided (e.g., transmitted) to the user apparatus 20 corresponding to the second user to request feedback regarding whether the second user would like to cancel the second travel plan or modify the second travel plan so that it no longer conflicts with the first travel plan. In an example embodiment, the feedback request may suggest one or more ways in which the second user may modify the second travel plan so that it no longer conflicts with the first travel plan. The second user apparatus 20B may present the feedback request to the second user (e.g., via a user interface 28) and receive feedback indicating a user-selected response to the feedback request (e.g., via the user interface 28). The second user apparatus 20B may provide (e.g., transmit) the received feedback to the integration apparatus 10 and the integration apparatus 10 may generate the conflict-resolved travel plan based thereon.

After generating the conflict-resolved travel plan, the integration apparatus may store the conflict resolved travel plan (e.g., in memory 14 and/or the like), provide the conflict-resolved travel plan to one or more user apparatuses 20, and/or provide the conflict-resolved travel plan to one or more vehicle apparatuses 30. In an example embodiment, the client application 25 operating on a user apparatus 20 may be configured to interface with other applications, modules, and/or programs operating on the user apparatus 20 such that the user's digital calendar, for example, may be updated based on the conflict-resolved travel plan.

When the user gets into the vehicle 5 and/or turns on the vehicle 5 within a trip beginning window of the first travel plan, the vehicle apparatus 30 may determine that the user is beginning the trip corresponding to the first travel plan. In an example embodiment, the trip beginning window is a period of time within 10 minutes, 5 minutes, 1 minute, and/or the like of the planned trip beginning time. In an example embodiment, the temporal length of the trip beginning window may be user dependent and determined based on user behavior pattern information/data stored in the user behavior pattern database 120. For example, if a first user usually starts trips 5-10 minutes before the planned trip beginning time and a second user usually starts a trip 2 minutes before to 2 minutes after the planned trip beginning time, the temporal length of the trip beginning window corresponding to the first user may be longer than the temporal length of the trip beginning window corresponding to the second user. In an example embodiment, the trip beginning time for the trip may be determined based on user behavior pattern information/data corresponding to patterns of when the corresponding user starts their trips (e.g., rather than the temporal length of the trip beginning window be changed).

In an example embodiment, when the vehicle apparatus 30 determines that the user is beginning the trip corresponding to the first travel plan, the vehicle apparatus 30 may access the planned route of the first travel plan and provide (e.g., display, audibly provide, and/or the like) the planned route to the user (e.g., via a user interface of the vehicle apparatus 30). In one example embodiment, the first user apparatus 20A may access and provide the planned route of the first travel plan at the planned trip beginning time and/or during the trip beginning window. In another example, the vehicle apparatus 30 may cause the vehicle 5 (e.g., by controlling one or more systems 8) to start autonomously driving along the planned route. It should be understood that a new route may be determined after the start of the trip; however, use of the planned route to start the trip reduces the delay in the starting of the trip as the trip can begin as soon as the user is ready to begin the trip without any input, processing and/or route determination delays. In an example embodiment, when the vehicle apparatus 30 determines that the user is beginning the trip corresponding to the first travel plan, the vehicle apparatus 30 may control one or more systems 8 of the vehicle 5 in accordance with user preferences stored as part of the first travel plan. For example, the vehicle apparatus 30 may control one or more systems 8 to adjust the driver's seat position in accordance with the user's seat position preferences, adjust the side view mirrors and/or rear view mirror in accordance with the user's mirror preferences, adjust the radio and/or entertainment system of the vehicle 5 in accordance with the user's radio and/or entertainment system preferences (e.g., tune to a preferred radio station, and/or the like), adjust the steering wheel position in accordance with the user's steering wheel preferences, adjust one or more handling parameters of the response and handling systems in accordance with the user's handling preferences, and/or the like. For example, the vehicle apparatus may control one or more systems 8 (e.g., driver assistance systems, safety systems, various engine systems, response and handling systems, suspension systems, and/or the like) in accordance with user preferences and/or supplemental trip information/data (e.g., expected weather and/or traffic information/data and/or the like) stored as part of the first travel plan. For example, if the expected weather information/data indicates a particular expected road condition, a response and handling system of the vehicle 5 may be automatically adjusted for maneuvering on roadways of the expected road condition.

The data mining engine 105, navigation engine 110, conflict resolution engine 115, and behavior pattern engine 125 are illustrated as separate modules operated by the integration apparatus 10 in FIG. 3. This architecture is provided as illustrative and not as limiting. For example, various architectures may be used to implement the functions described herein. For example, in various embodiments, the functions described with respect to the data mining engine 105, navigation engine 110, conflict resolution engine 115, and/or behavior pattern engine 125 may be implemented by one or more modules, applications, programs, and/or the like being executed by one or more processors (e.g., the processor 12).

In an example embodiment, a real time or near real time conflict check and conflict resolution/avoidance may also be performed. For example, if a first user is taking a trip using a first vehicle and a second user is scheduled to take a different trip with the first vehicle shortly after the first user completes their trip, a real time or near real time conflict check may be performed. In another example embodiment, it may be identified that a user is experiencing unexpected delays during their trip and it may be determined if the unexpected delays will cause a conflict with any second travel plans of the conflict-resolved travel plan. For example, a first user may be taking a trip using the first vehicle and experience heavier traffic than expected, take longer completing an errand than expected, and/or the like. This unexpected delay may be identified (e.g., by the vehicle apparatus 30, integration apparatus 10, and/or user apparatus 20) and the conflict resolution engine 115 may determine if the unexpected delay is likely to cause a conflict with a second travel plan of the conflict-resolved travel plan. For example, if a second user is scheduled to begin a trip shortly after the first user completes their trip, the unexpected delay may be likely to cause a conflict with the second user's travel plan. If the second user is scheduled to begin a trip several hours after the first user completes their trip, the unexpected delay is less likely to cause a conflict with the second user's travel plan. In an example embodiment, the conflict may be a timing conflict, an available fuel/energy conflict (e.g., if the first user is traveling in heavy traffic their fuel/energy consumption may be different than expected for the trip), and/or the like. If it is determined that the unexpected delay in the first user's trip is likely to cause a conflict with a second travel plan of the conflict-resolved travel plan, a new conflict-resolved travel plan may be determined and/or generated (and/or the previously determined conflict-resolved travel plan may be updated) based on the collaboration plan 130, the previously determined conflict-resolved travel plan, the estimated effect of the unexpected delay on the first user's trip, and/or the like. The integration apparatus 10 may continue to determine and/or generate new conflict-resolved travel plan and/or update the previously determined conflict-resolved travel plan as additional information/data regarding the unexpected delay becomes available (e.g., via the vehicle apparatus 30, user apparatus 20, and/or other computing entity 40). For example, current traffic information/data may be received from the computing entity 40 indicating that the unexpected delay in the first user's trip is 15 minutes due to unexpectedly heavy traffic and a new conflict-resolved travel plan may be determined and/or generated and/or a previously determined conflict-resolved travel plan may be updated based thereon. Thus, the effect of the unexpected delay on the second travel plans of the conflict-resolved travel plan may be determined and/or mitigated and any resulting conflicts may be resolved and/or avoided in real time and/or near real time.

### Exemplary Operation of the User Apparatus

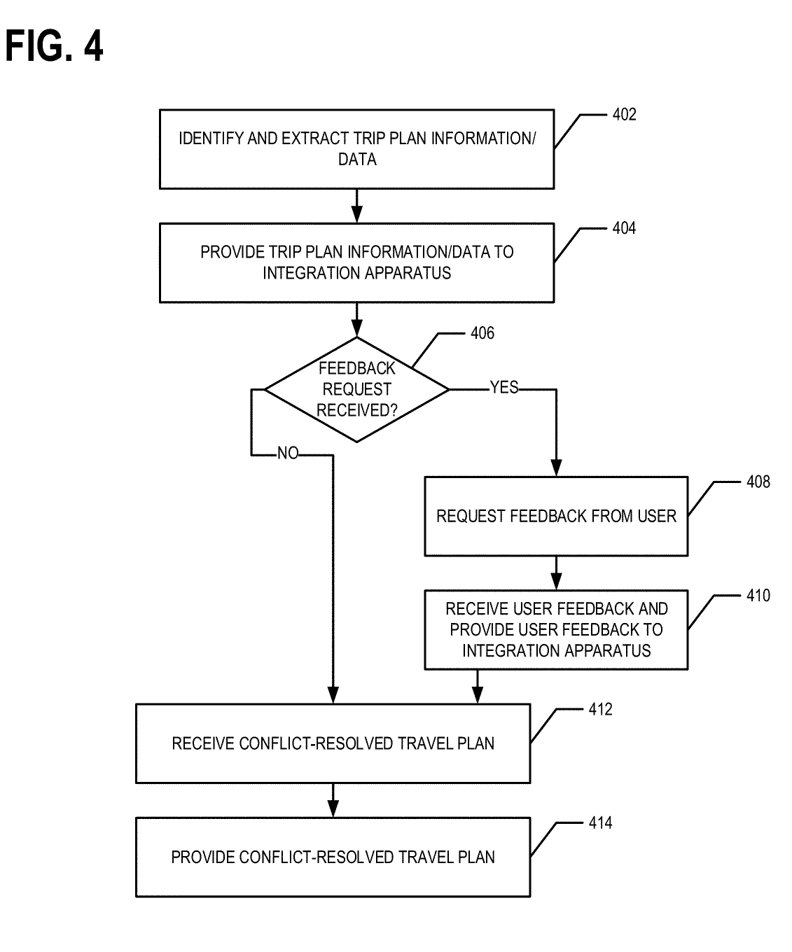

FIG. 4 provides a flowchart illustrating an example operation of a first user apparatus 20, according to an example embodiment, to provide a conflict-resolved travel plan. In an example embodiment, a client application 25A operates on the first user apparatus 20A and is configured to receive from and provide to (e.g., transmit) the integration apparatus 10 information/data relating to trip plans, feedback requests, and/or conflict-resolved travel plans. In an example embodiment, the client application 25A may be configured to interface with one or more other applications, programs, and/or modules operating on the user apparatus 20 (e.g., via an application programming interface (API) and/or the like) to identify and extract trip plan information/data, to update the first user's digital calendar based on a conflict-resolved trip plan, and/or the like.

Starting at block 402, first trip plan information/data corresponding to a first trip is identified and/or extracted. For example, the first user apparatus 20A may identify and/or extract first trip plan information/data. For example, the first user apparatus 20A may comprise means, such as the processor 22, memory 24, and/or the like, configured for identifying and/or extracting first trip plan information/data. For example, a client application 25 may be executed by the processor 22. The client application 25 may be configured to interface with one or more other applications, programs, and/or modules operating on the user apparatus 20 (e.g., being executed by the processor 22 and/or the like). The client application 25 may then identify and extract the first trip plan information/data from the one or more other applications, programs, and/or modules. For example, the client application 25 may interface with a digital calendar on the user apparatus 20 to identify and/or extract first trip plan information/data stored in the digital calendar. In an example embodiment, the first trip plan information/data may comprise a date, time (e.g., an arrival time and/or an arrive by time), a destination (e.g., an address, a point of interest identifier and/or name, and/or the like), and/or other data corresponding to the first trip plan (e.g., other users that are going on the first trip, a preferred vehicle for the first trip, and/or the like).

At block 404, the identified and/or extracted first trip plan information/data is provided to the integration apparatus 10. For example, the user apparatus 20 may provide (e.g., transmit) the identified and/or extracted first trip plan information/data to the integration apparatus 10. For example, the user apparatus 20 comprises means, such as the processor 22, communication interface 26, and/or the like, configured for providing (e.g., transmitting) the identified and/or extracted first trip plan information/data to the integration apparatus 10.

At block 406, it is determined if a feedback request has been received. For example, the user apparatus 20 may determine if a feedback request has been received. For example, the user apparatus 20 may comprise means, such as the processor 12 and/or the like, configured to determine if a feedback request has been received (e.g., via the communication interface 26 and/or the like). If it is determined that a feedback request has been received at block 406, the process may continue to block 408. At block 408, the feedback request is provided to the user. For example, the user apparatus 20 may provide the feedback request and/or a portion/representation thereof to the user. For example, the user apparatus 20 may comprise means, such as the processor 22, user interface 28, and/or the like, configured to provide the feedback request and/or a portion/representation thereof to the user. For example, the user interface 28 may display or audibly provide a request for feedback to the user. For example, the request for feedback may provide the user with information/data corresponding to a conflict and/or potential conflict between the first travel plan corresponding to the first trip and one or more second travel plans and provide the user with one or more selectable options. For example, the selectable options may include a selectable option for canceling or not planning the first trip, a selectable option for modifying the first travel plan corresponding to the user (e.g., changing the date, time, destination, and/or the like of the first trip), a selectable option indicating that the user does not wish to cancel or modify the first travel plan, and/or the like.

At block 410, user input selecting a selectable option for responding to the feedback request is received. For example, the first user apparatus 20A may receive user input selecting a selectable option for responding to the feedback request. For example, the first user apparatus 20A may comprise means, such as the processor 22, user interface 28, and/or the like, for receiving user input selecting a selectable option for responding to the feedback request. For example, a user may press, select, and/or interact with a hard or soft keyboard; press or touch a region of a touchscreen display; provide an audible/vocal selection; use a mouse, remote control, joy stick, and/or otherwise provide input to select a user selectable option for responding to the feedback request.

At block 412, a conflict-resolved travel plan is received. For example, the user apparatus 20 may receive a conflict-resolved travel plan. For example, the first user apparatus 20A may comprise means, such as the processor 22, communication interface 26, and/or the like, configured to receive a conflict-resolved travel plan. For example, the integration apparatus 10 may provide (e.g., transmit) a conflict-resolved travel plan to the first user apparatus 20A. In an example embodiment, the conflict-resolved travel plan comprises a first travel plan corresponding to the first trip (as long as the user did not provide input canceling the first trip in response to a feedback request). The user apparatus may receive the conflict-resolved travel plan and provide the conflict-resolved travel plan to the client application 25. The client application may interface with one or more other applications, programs, and/or modules operating on the user apparatus (e.g., via an API and/or the like) to update the one or more other applications, programs, and/or modules based on the conflict-resolved travel plan. For example, the client application 25 may interface with a digital calendar on the user apparatus to update the digital calendar based on one or more trips of the conflict-resolved travel plan. For example, the digital calendar on the first user apparatus 20A may be updated based on first travel plan information/data. For example, the digital calendar may be updated to reflect the planned trip beginning time for the first trip.

At block 414, the conflict-resolved travel plan, and/or a portion thereof, may be provided to the user. For example, the user apparatus 20 may provide at least a portion of the conflict-resolved travel plan to the user. For example, the user apparatus 20 may comprise means, such as the processor 22, user interface 28, and/or the like, configured to provide at least a portion of the conflict-resolved travel plan to the user. For example, the user apparatus may display and/or audibly provide (e.g., via the user interface 28) at least a portion of the conflict-resolved travel plan. For example, the user apparatus may display the planned trip beginning time for the first trip and/or other first travel plan information/data (e.g., expected weather information/data, expected traffic information/data, expected travel time, a vehicle to be used for the first trip, and/or the like). In an example embodiment, the first user apparatus 20A may provide the planned route, a reminder of the planned trip beginning time, and/or the like.

### Exemplary Operation of the Integration Apparatus

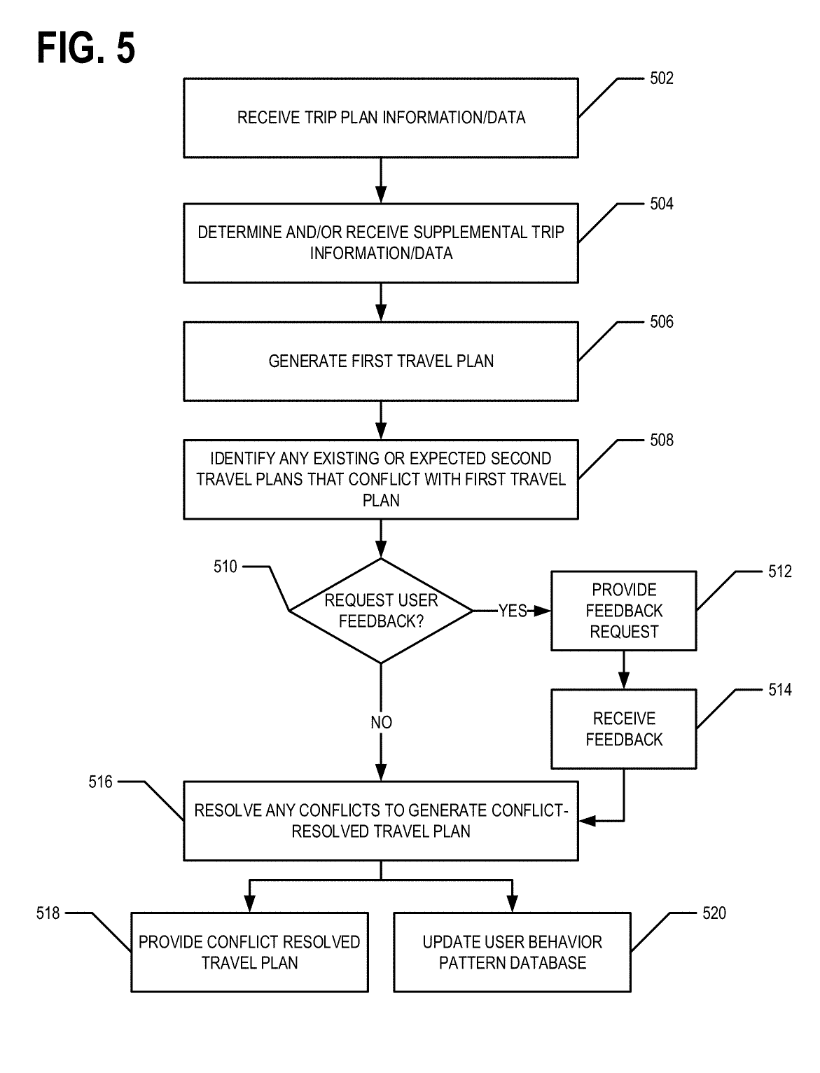

FIG. 5 provides a flowchart illustrating an example operation of the integration apparatus 10, according to an example embodiment, to provide a conflict-resolved travel plan. Starting at block 502, first trip plan information/data corresponding to a first trip is received. For example, the integration apparatus 10 may receive first trip plan information/data. For example, the integration apparatus 10 may comprise means, such as the processor 12, communication interface 16, and/or the like, configured for receiving the first trip plan information/data. For example, the first user apparatus 20A may provide (e.g., transmit) first trip plan information/data and the integration apparatus 10 receives the first trip plan information/data.

At block 504, supplemental trip information/data may be determined and/or requested and/or received corresponding to the first trip. For example, at least some aspects of supplemental trip information/data may be determined. In another example, at least some aspects of supplemental trip information/data may be requested and/or received from the computing entities 40 and/or vehicle apparatus 30. For example, the integration apparatus 10 may determine at least some aspects of supplemental trip information/data. For example, the integration apparatus 10 may comprise means, such as processor 12, memory 14, and/or the like, for determining at least some aspects of supplemental trip information/data. For example, the integration apparatus 10 may request and/or receive at least some aspects of supplemental trip information/data. For example, the integration apparatus 10 may comprise means such as the processor 12, communication interface 16, and/or the like, configured for requesting and/or receiving at least some aspects of supplemental trip information/data. For example, the integration apparatus may interface with a vehicle apparatus 30 onboard the vehicle 5 to be driven and/or used for the first trip to determine maintenance needed (e.g., an oil change, a brake light replaced, refueling or battery recharging, repairs, and/or the like) prior to, during, and/or directly after the trip. In another example, the integration apparatus 10 may determine a planned route for the first trip, expected traffic information/data for the first trip (e.g., based on historical traffic information/data), an expected energy consumption (e.g., gasoline, diesel, electric battery depletion) for the first trip, expected driving effort for the first trip, and/or the like. In an example embodiment, the expected energy consumption for the first trip is based on the planned route for the first trip, expected traffic information/data for the first trip, expected weather information/data for the first trip, user driving habits for the first user (e.g., as indicated and/or identified by the user behavior information/data stored in the user behavior pattern database 120), and/or the like. In another example, the integration apparatus 10 may communicate with one or more external and/or remote apparatuses and/or computing entities 40 to determine, for example, expected weather information/data for the trip. In an example embodiment, the integration apparatus 10 may communicate with the vehicle apparatus 30 to determine an expected energy availability at the beginning of the first trip (e.g., gasoline or diesel level, battery charge level, and/or the like) and/or other vehicle maintenance information/data (e.g., relating to oil changes, fault conditions, and/or the like). For example, the supplemental trip information/data may comprise a combination of expected energy consumption, expected driving effort, expected traffic information/data, expected weather information/data, a planned route, planned trip beginning time, an expected travel time, necessary and/or suggested maintenance that should be performed prior to, during, and/or directly after the first trip, and/or other information/data corresponding to the first trip, in an example embodiment.

At block 506, the first travel plan is generated. For example, the first travel plan comprises first travel plan information/data. The first travel plan information/data comprises at least some aspects of first trip plan information/data and at least some aspects of supplemental trip information/data corresponding to the first trip. For example, the first travel plan information/data may comprise a date, planned trip beginning time, expected arrival time and/or an arrive by time, a planned route, a destination, expected energy consumption (e.g., gasoline, diesel, electric), expected driving effort, expected travel time, expected traffic information/data, expected weather information/data, any necessary and/or suggested maintenance, and/or the like corresponding to the first trip. For example, the integration apparatus 10 may determine and/or generate a first travel plan. For example, the integration apparatus 10 may comprise means, such as the processor 12, memory 14, and/or the like, configured for determining and/or generating a first travel plan.

At block 508, any second travel plans that conflict with the first travel plan are identified. For example, a second travel plan conflicts with the first travel plan if the first and second travel plans correspond to the same vehicle and the corresponding trips overlap in time, if maintenance would need to be performed between the corresponding trips but there will not be sufficient time to perform the maintenance (e.g., if the electric battery would need to be recharged and there is not sufficient time between the expected end time of one trip and the planned trip beginning time of the other trip), if a user taking the first trip would interfere with another user taking the second trip or vice versa, and/or the like. For example, the date, expected travel time, planned trip beginning time, expected energy usage, and/or other first travel plan information/data and/or other second travel plan information/data may be used to determine if a first travel plan and a second travel plan conflict. For example, the integration apparatus 10 may store (e.g., in memory 14) a previous conflict-resolved travel plan comprising one or more second travel plans. Additionally, the user behavior pattern database 120 may comprise one or more template travel plans corresponding to expected travel plans based on trips regularly taken by one or more users. The integration apparatus 10 may determine if any of the second travel plans (existing, previously planned travel plans and/or expected travel plans corresponding to a template travel plan) conflict with the first travel plan. For example, the integration apparatus 10 may comprise means, such as the processor 12 and/or the like, configured to identify any second travel plans (existing, previously planned travel plans and/or expected travel plans corresponding to a template travel plan) conflict with the first travel plan. In an example embodiment, the integration apparatus 10 may identify zero, one, or more second travel plans that conflict with the first travel plan.

At block 510, it is determined if a feedback request is to be provided. For example, the integration apparatus 10 may determine if a feedback request is to be provided. For example, the integration apparatus 10 may comprise means, such as processor 12 and/or the like, configured to determine if a feedback request is to be provided. For example, it may be determined if the user behavior pattern database 120 comprises user behavior pattern information/data and/or the collaboration plan 130 comprises one or more collaboration levels that indicate that a feedback request should or should not be provided. For example, a collaboration level corresponding to a first user and a second user may indicate that a feedback request should be provided to the first or second user any time there is a conflict between a first travel plan corresponding to the first user and a second travel plan corresponding to the second user. In another example, if the first travel plan conflicts with an expected travel plan and/or a template travel plan corresponding to a second user, a feedback request may be provided to determine if the second user is planning to take a second trip corresponding to the expected and/or template travel plan. In an example embodiment, the user behavior pattern database may not comprise sufficient user behavior pattern information/data and/or the collaboration level corresponding to the first user and the second user may not provide sufficient information/data to determine how to resolve the conflict and a feedback request may be provided to determine how to resolve the conflict.

If it is determined at block 510 that a feedback request is to be provided, the feedback request is generated and provided at block 512. For example, the integration apparatus 10 may generate and provide (e.g., transmit) a feedback request to the appropriate user apparatus 20. For example, the feedback request may be provided to the user apparatus 20 corresponding to the user the feedback is being requested from (e.g., the first or second user). For example, the integration apparatus 10 may comprise means, such as processor 12, communication interface 16, and/or the like, configured for generating and providing a feedback request to the appropriate user apparatus 20. For example, the feedback request may comprise one or more questions to be asked of the user, one or more response options to be provided to the user as user-selectable options, travel plan information/data corresponding to the first and/or second travel plans (wherein the first and second travel plans conflict), and/or the like.

At block 514, feedback is received in response to the feedback request. For example, the user apparatus 20 may receive the feedback request and provide (e.g., display, audibly provide, and/or the like) the feedback request and/or a portion/representation thereof to the user. The user apparatus 20 may receive user feedback selecting a user-selectable option and/or providing input responding to the feedback request. The user apparatus 20 may then provide (e.g., transmit) an indication of the user-selected option and/or input provided by the user. For example, the integration apparatus 10 may receive the feedback. For example, the integration apparatus 10 may comprise means, such as the processor 12, communication interface 16, and/or the like, configured for receiving the feedback. For example, the feedback may provide and/or indicate an answer to the question provided to the user. For example, the feedback may comprise user conflict resolution choices. For example, if the second travel plan (that conflicts with the first travel plan) is a template travel plan, the feedback may comprise an indication of whether the second user intends to take a trip corresponding to the template travel plan in accordance with the template travel plan, if the user intends and/or is willing to take a trip corresponding to the template travel plan that is modified from the template travel plan (e.g., on a different date, at a different time, to a different destination), or if the user is not intending to take a trip corresponding to the template travel plan. In some instances, the feedback may resolve and/or avoid the conflict between the first and second travel plans.

At block 516, any remaining conflicts are resolved and a conflict-resolved travel plan is determined and/or generated. For example, the integration apparatus 10 may resolve any remaining conflicts and determine and/or generate the conflict-resolved travel plan. For example, the integration apparatus 10 may comprise means, such as the processor 12 and/or the like, configured for resolving any remaining conflicts and determining and/or generating the conflict-resolved travel plan. For example, the integration apparatus 10 may determine if, after receiving the feedback, a conflict still exists between the first travel plan and at least one second travel plan. If a conflict still exists between the first travel plan corresponding to the first user and a second travel plan corresponding to a second user, the integration apparatus 10 may use the collaboration level corresponding to the first user and the second user to modify and/or cancel at least one of the first travel plan and the second travel plan to resolve the conflict between the first travel plan and the second travel plan and to determine and/or generate the conflict-resolved travel plan. In an example embodiment the integration apparatus 10 may use user behavior pattern information/data from the user behavior pattern database 120 corresponding to the first and/or second user in addition to and/or instead of the collaboration level corresponding to the first user and the second user to modify and/or cancel at least one of the first travel plan and the second travel plan to resolve the conflict between the first travel plan and the second travel plan and to determine and/or generate the conflict-resolved travel plan.

For example, the collaboration plan 130 may indicate that the first user has priority over the second user. Thus, in a scenario where the first travel plan corresponding to the first user conflicts with a second travel plan corresponding to the second user, the conflict may be resolved by providing a feedback request to the second user indicating that the second user needs to modify or cancel the second trip corresponding to the second travel plan. The conflict-resolved travel plan may then be generated based on the user feedback received in response to the feedback request regarding canceling or modifying the second trip. In another example, the user behavior pattern database 120 may comprise user behavior information/data that indicates that a similar previous conflict between a first travel plan corresponding to the first user and a second travel plan corresponding to the second user was resolved by modifying the first travel plan to leave fifteen minutes earlier so that the first user and the second user could share the vehicle. In another example, a conflict between a first travel plan corresponding to the first user and a second travel plan corresponding to the second user may be resolved by assigning a first car to the first travel plan and a second car to the second travel plan based on previous vehicle usage corresponding to the first and second users as indicated by user behavior pattern information/data and/or based on user preferences and/or priorities indicated by the collaboration level corresponding to the first and second user. Thus, any remaining conflict between the first travel plan and a second travel plan may be resolved through user feedback (e.g., comprising user conflict resolution choices) in response to a feedback request and/or application of the corresponding to collaboration level of the collaboration plan 130. As described in more detail above, the collaboration plan 130 may comprise one or more aspects determined, designated, and/or defined via user input and one or more aspects determined, designated, and/or defined based on patterns identified in the user behavior pattern information/data stored in the user behavior pattern database 120. The conflict-resolved travel plan is then determined and/or generated based on the first travel plan and the second travel plan after resolution of the conflict.

At block 518, the conflict-resolved travel plan is provided. For example, the integration apparatus 10 may provide (e.g., transmit) the conflict-resolved travel plan to one or more user apparatuses 20 and/or vehicle apparatuses 30. For example, the integration apparatus 10 may comprise means, such as processor 12, communication interface 16, and/or the like, configured for providing (e.g., transmitting) the conflict-resolved travel plan to one or more user apparatuses 20 and/or vehicle apparatuses 30. For example, in an example embodiment, the conflict-resolved travel plan may be provided to each user apparatus 20 of the set of user apparatuses corresponding to the group of N users. In an example embodiment, the conflict-resolved travel plan may be provided to each vehicle apparatus 30 corresponding to the set of M vehicles 5. In another example embodiment, the conflict-resolved travel plan and/or portions thereof may only be provided to the users and/or vehicles 5 corresponding to the individual travel plans comprising the conflict-resolved travel plan. For example, portions of the conflict-resolved travel plan corresponding to trips to be taken by the first user may be provided to the first user apparatus 20A. In another example, portions of the conflict-resolved travel plan corresponding to trips to be taken by a first vehicle may be provided to the first vehicle apparatus 30A.

In an example embodiment, the conflict-resolved travel plan provided to a vehicle apparatus 30 may comprise or reference computer-executable instructions to be executed by the vehicle apparatus 30 to cause the vehicle apparatus 30 to provide a route and/or other travel plan information/data (e.g., via a display or speakers in communication with the vehicle apparatus 30) and/or to control one or more systems 8 of the vehicle 5 in accordance with the conflict-resolved travel plan. For example, in an example embodiment, generating the conflict-resolved travel plan may comprise generating the computer-executable instructions and/or identifying and generating the references to the computer-executable instructions corresponding to the conflict-resolved travel plan.

At block 520, the user behavior pattern database 120 may be updated to reflect the conflict-resolved travel plan, any indication of user feedback received, an indication of how any conflicts were resolved, and/or the like. For example, the integration apparatus 10 may update the user behavior pattern database 120 based on the conflict-resolved travel plan, any indication of user feedback received, an indication of how any conflicts were resolved, and/or the like. For example, the integration apparatus 10 may comprise means, such as the processor 12, memory 14, and/or the like for updating the user behavior pattern database 120 based on the conflict-resolved travel plan, any indication of user feedback received, an indication of how any conflicts were resolved, and/or the like. In an example embodiment, the integration apparatus 10 may analyze at least a portion of the user behavior information/data stored in the user behavior pattern database 120 to identify and/or determine new or changed user behavior patterns and/or to enhance previously identified user behavior patterns (e.g., determine and/or identify further information/data related thereto). In an example embodiment, the user behavior database 120 and/or the collaboration plan 130 may be updated to reflect any new, changed, and/or enhanced user behavior patterns identified, determined, and/or the like.

### Exemplary Operation of the Vehicle Apparatus

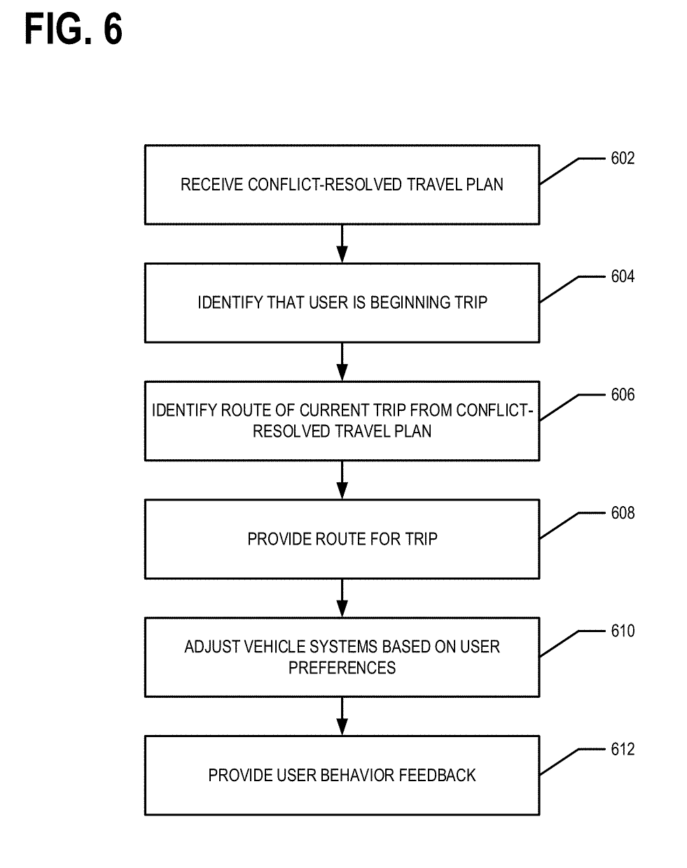

FIG. 6 provides a flowchart illustrating an example operation of the vehicle apparatus 30, according to an example embodiment. For example, the vehicle apparatus 30 onboard vehicle 5 may receive a conflict-resolved travel plan or at least a portion thereof. The conflict-resolved travel plan may comprise and/or reference computer-executable instructions configured to cause the vehicle apparatus 30 to control the user interface 38, respond to signals received from one or more sensors 39, and/or control one or more systems 8 of the vehicle 5 in accordance with one or more travel plans corresponding to the vehicle 5.

Starting at block 602, a conflict-resolved travel plan and/or a portion thereof is received. For example, the vehicle apparatus 30 may receive a conflict-resolved travel plan and/or a portion thereof. For example, the vehicle apparatus 30 may comprise means, such as processor 32, memory 34, communication interface 36, and/or the like, for receiving a conflict-resolved travel plan and/or a portion thereof. In an example embodiment, the conflict-resolved travel plan may comprise and/or reference computer-executable instructions for execution by the vehicle apparatus 30 to cause the vehicle apparatus to provide (e.g., display, audibly provide, and/or the like) a route of a trip of the conflict-resolved travel plan, control one or more systems 8 of the vehicle 5 in accordance with the conflict-resolved travel plan, and/or the like. In an example embodiment, the conflict-resolved travel plan and/or the portion thereof received by the vehicle apparatus 30 comprises first travel plan information/data (and/or computer-executable instructions relating thereto) corresponding to a first travel plan for a first trip to be taken with the vehicle 5.

A user may get into and/or start the vehicle 5. In response to the user getting into and/or starting the vehicle 5, the vehicle apparatus 30 may determine if the current time is within a trip beginning window of the first travel plan, at block 604. For example, in response to one or more sensors 39 indicating that a user has gotten into the vehicle 5, put on their seat belt, started the vehicle 5, and/or the like, the vehicle apparatus 30 may determine if the current time is within a trip beginning window for any of the trips of the conflict-resolved travel plan. In an example embodiment, the trip beginning window is a period of time within 10 minutes, 5 minutes, 1 minute, and/or the like of the planned trip beginning time. In an example embodiment, the temporal length of the trip beginning window may be user dependent and determined based on user behavior pattern information/data stored in the user behavior pattern database 120. For example, if a first user usually starts trips 5-10 minutes before the planned trip beginning time and a second user usually starts a trip 2 minutes before to 2 minutes after the planned trip beginning time, the temporal length of the trip beginning window corresponding to the first user may be longer than the temporal length of the trip beginning window corresponding to the second user. When the user gets in the vehicle 5, put on their seatbelt, turns on the vehicle 5 and/or the like within a trip beginning window of the first travel plan, the vehicle apparatus 30 may determine that the user is beginning the first trip corresponding to the first travel plan.

In response to determining that the user is beginning the first trip, the planned route of the first trip is identified, at block 606. For example, the first travel plan information/data may comprise a planned route for the first trip. For example, the vehicle apparatus 30 may identify the planned route for the first trip from the conflict-resolved travel plan. For example, the vehicle apparatus 30 may comprise means, such as the processor 32 and/or the like, configured for identifying a planned route for the first trip from the conflict-resolved travel plan. For example, the planned route may comprise instructions for traveling to the destination of the first trip from the current location of the vehicle 5 and/or the expected starting location of the first trip.

At block 608, the planned route for the first trip is provided. For example, the vehicle apparatus 30 may provide the planned route for the first trip. For example, the vehicle apparatus 30 may comprise means, such as the processor 32, user interface 36, and/or the like, configured for providing the planned route for the first trip. For example, the vehicle apparatus 30 may display and/or audibly provide the planned route for the first trip via the user interface 36. In an example embodiment, the planned route may be provided in real time or near real time with respect to the user getting into the vehicle 5, putting on their seatbelt, turning on the vehicle 5, and/or the like.

At block 610, one or more systems 8 of the vehicle 5 may be controlled and/or adjusted based on the conflict-resolved travel plan. For example, the vehicle apparatus 30 may control and/or adjust one or more systems 8 of the vehicle 5 based on the conflict-resolved travel plan. For example, the vehicle apparatus 30 may comprise means, such as processor 32, communication interface 36, and/or the like, configured for controlling and/or adjusting one or more systems 8 of the vehicle 5 based on the conflict-resolved travel plan. For example, the first travel plan information/data may include information/data relating to user preferences for the first user taking the first trip. In an example embodiment, the conflict-resolved travel plan comprises computer-executable instructions, and/or reference thereto, that causes the vehicle apparatus 30 to control one or more system 8 of the vehicle 5 in accordance with user preferences for the first user taking the first trip. For example, the vehicle apparatus 30 may control one or more systems 8 to adjust the driver's seat position in accordance with the user's seat position preferences, adjust the side view mirrors and/or rear view mirror in accordance with the user's mirror preferences, adjust the radio and/or entertainment system of the vehicle 5 in accordance with the user's radio and/or entertainment system preferences (e.g., tune to a preferred radio station, and/or the like), adjust the steering wheel position in accordance with the user's steering wheel preferences, adjust one or more handling parameters of the response and handling systems in accordance with the user's handling preferences or the expected weather information/data, and/or the like. For example, the vehicle apparatus may control one or more systems 8 (e.g., driver assistance systems, safety systems, various engine systems, response and handling systems, suspension systems, and/or the like) in accordance with user preferences, expected weather information/data, expected traffic information/data, and/or other supplemental trip information/data stored as part of the first travel plan. In an example embodiment, the vehicle apparatus 30 may control one or more systems 8 of the vehicle 5 to autonomously drive the vehicle 5 along the route for the first trip, assist in driving the vehicle 5 along the route for the first trip, and/or the like. In an example embodiment, the vehicle apparatus 30 may control and/or adjust one or more systems 8 of the vehicle 5 in real time or near real time with respect to the user getting into, buckling their seatbelt, turning on the vehicle 5, and/or the like.

At block 612, the user behavior feedback may be provided. For example, the vehicle apparatus 30 may provide user behavior feedback. For example, the vehicle apparatus 30 may comprise means, such as the processor 32, communication interface 36, and/or the like, configured for providing user behavior feedback. For example, the vehicle apparatus 30 may provide the user behavior feedback to the integration apparatus 10 for inclusion in the user behavior pattern database 120, such that new user behavior patterns may be identified, determined, and/or the like for application to future travel plans. For example, if the user adjusts the seat position, radio station, mirror position, steering wheel position, ventilation system, and/or the like, the processor 32 may identify signals from one or more of the sensors 39 identifying the adjustment. The vehicle apparatus 30 may then provide an indication of the adjustment to the integration apparatus 10.

### Advantages

Various embodiments provide improvements to technology relating to trip planning and navigation. For example, example embodiments may prevent and resolve conflict between multiple users planning trips that use the same vehicle or vehicles from a set of vehicles. Example embodiments provide benefits such as reducing delay at the beginning of a trip due to a user needing to enter trip plan information/data (e.g., a destination) at the beginning of the trip and a route for the trip needing to be determined. Additionally, example embodiments, provide the advantage of real time or near real time re-evaluation of a conflict-resolved travel plan such that unexpected delays in a first trip are identified in real time or near real time and the effects on a second trip may be mitigated. Example embodiments provide further advantages such as the automatic controlling and/or modification of one or more systems of the vehicle based on user behavior patterns and other aspects of the conflict-resolved travel plan. Example embodiments further provide an optimized use of a vehicle's fuel/energy supply in view of future and/or expected vehicle use. For example, example embodiments may reduce untimely refueling and/or recharging of a vehicle and provide efficient energy management of the vehicle's fuel/energy resources.

### III. Example Apparatus

The vehicle apparatus 30, user apparatus 20, computing entity 40, and/or integration apparatus 10 of an example embodiment may be embodied by or associated with a variety of computing devices including, for example, a navigation system including an in-vehicle navigation system, a vehicle control system, a personal navigation device (PND) or a portable navigation device, an advanced driver assistance system (ADAS), a global navigation satellite system (GNSS), a cellular telephone, a mobile phone, a personal digital assistant (PDA), a watch, a camera, a computer, and/or other device that can perform navigation-related functions, such as digital routing and map display. Additionally or alternatively, the vehicle apparatus 30, user apparatus 20, computing entity 40, and/or integration apparatus 10 may be embodied in other types of computing devices, such as a server, a personal computer, a computer workstation, a laptop computer, a plurality of networked computing devices or the like, that are configured to update one or more map tiles, analyze probe points for route planning or other purposes. In an example embodiment, a vehicle apparatus 30 is an in-vehicle navigation system onboard a vehicle 5; an integration apparatus 10 is a server configured to provide Cloud-based computing resources to one or more vehicle apparatuses 30 and/or user apparatuses 20; a user apparatus 20 is a user's mobile phone, tablet, laptop, or desktop computer; and a computing entity 40 is a traffic management system, weather information/data system, and/or the like. In this regard, FIG. 2A depicts an integration apparatus 10, FIG. 2B depicts a user apparatus 20, and FIG. 2C depicts a vehicle apparatus 30 of an example embodiment that may be embodied by various computing devices including those identified above. As shown, the integration apparatus 10 of an example embodiment may include, may be associated with, or may otherwise be in communication with a processor 12 and a memory device 14 and optionally a communication interface 16 and/or a user interface 18. Similarly, a user apparatus 20 of an example embodiment may include, may be associated with, or may otherwise be in communication with a processor 22 and a memory device 24 and optionally a communication interface 26 and/or a user interface 28. A vehicle apparatus 30 of an example embodiment may include, may be associated with, or may otherwise be in communication with a processor 32, and a memory device 34, and optionally a communication interface 36, a user interface 38, one or more sensors 39 (e.g., a location sensor such as a GNSS sensor, IMU sensors, and/or the like; camera(s); 2D and/or 3D LiDAR(s); long, medium, and/or short range RADAR; ultrasonic sensors; electromagnetic sensors; (near-)IR cameras, 3D cameras, 360° cameras; and/or other sensors that enable the probe apparatus to determine one or more features of the corresponding vehicle's 5 surroundings), and/or other components configured to perform various operations, procedures, functions, or the like described herein. In example embodiments, a computing entity 40 may, similar to the integration apparatus 10, user apparatus 20, and/or vehicle apparatus 30, comprise a processor, memory device, communication interface, user interface, and/or one or more additional components configured to perform various operations, procedures, functions, or the like described herein. In an example embodiment, a computing entity 40 may comprise one or more sensors similar to the one or more sensors 39.

In some embodiments, the processor 12, 22, 32 (and/or co-processors or any other processing circuitry assisting or otherwise associated with the processor) may be in communication with the memory device 14, 24, 34 via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the integration apparatus 10, user apparatus 20, computing entity 40, and/or vehicle apparatus 30 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22, 32 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 12, 22, 32 may be configured to execute instructions stored in the memory device 14, 24, 34 or otherwise accessible to the processor. For example, the processor 32 may be configured to execute computer-executable instructions embedded within a link record of a map tile and/or provided as part of a conflict-resolved travel plan. In an example embodiment, the processor 22 may execute computer-executable instructions corresponding to the client application 25. In an example embodiment, the processor 12 may execute computer-executable instructions corresponding to the data-mining engine 105, navigation engine 110, conflict-resolution engine 115, to identify patterns in the user behavior pattern information/data, and/or the like. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the integration apparatus 10, computing entity 40, user apparatus 20, and/or vehicle apparatus 30 may include a user interface 18, 28, 38 that may, in turn, be in communication with the processor 12, 22, 32 to provide output to the user, such as a proposed route and/or a feedback request, and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22, 32 (e.g., memory device 14, 24, 34, and/or the like).

The integration apparatus 10, computing entity 40, user apparatus 20, and/or the vehicle apparatus 30 may optionally include a communication interface 16, 26, 36. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In addition to embodying the integration apparatus 10, computing entity 40, user apparatus 20, and/or vehicle apparatus 30 of an example embodiment, a navigation system may also include or have access to a geographic database that includes a variety of data (e.g., map information/data) utilized in constructing a route or navigation path, determining the time to traverse the route or navigation path, matching a geolocation (e.g., a GNSS determined location) to a point on a map and/or link, and/or the like. For example, a geographic database may include node data records (e.g., including anchor node data records comprising junction identifiers), road segment or link data records, point of interest (POI) data records and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records (e.g., node data records, link data records, POI data records, and/or other data records) may comprise computer-executable instructions, a reference to a function repository that comprises computer-executable instructions, one or more coefficients and/or parameters to be used in accordance with an algorithm for performing the analysis, one or more response criteria for providing a response indicating a result of the analysis, and/or the like. In an example embodiment, the integration apparatus 10 may be configured to modify, update, and/or the like one or more data records of the geographic database.

In an example embodiment, the road segment data records are links or segments, e.g., maneuvers of a maneuver graph, representing roads, streets, or paths, as can be used in the calculated route or recorded route information for determination of one or more personalized routes. The node data records are end points corresponding to the respective links or segments of the road segment data records. The road link data records and the node data records represent a road network, such as used by vehicles, cars, and/or other entities. Alternatively, the geographic database can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used. In an example embodiment, the geographic database may be updated based on information/data provided by one or more probe apparatuses.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases. Regardless of the manner in which the databases are compiled and maintained, a navigation system that embodies an integration apparatus 10, computing entity 40, user apparatus 20, and/or vehicle apparatus 30 in accordance with an example embodiment may determine the time to traverse a route that includes one or more turns at respective intersections more accurately.

### IV. Apparatus, Methods, and Computer Program Products

As described above, FIGS. 4, 5, and 6 illustrate flowcharts of apparatuses 10, 20, 30 methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24, 34 of an apparatus employing an embodiment of the present invention and executed by the processor 12, 22, 32 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor, at least one memory storing computer program code, with the at least one memory and the computer program code configured to, with the processor, cause the apparatus to at least:
receive trip plan data from a user apparatus corresponding to a first trip to be taken by a first user;
determine supplemental trip data corresponding to the trip plan data based at least in part on map data;
generate a first travel plan based at least in part on the trip plan data and the supplemental trip data;
identify a second travel plan associated with a second user, the second travel plan being an existing travel plan or an expected travel plan that conflicts with the first travel plan;
based on (a) a collaboration level corresponding to the first user and the second user, (b) the first travel plan, and (c) the second travel plan, generate a conflict-resolved travel plan that resolves the conflict between the first travel plan and the second travel plan; and
provide the conflict-resolved travel plan to a vehicle apparatus prior to the first user beginning the first trip.

2. The apparatus of claim 1, wherein the conflict-resolved travel plan comprises a planned route for the first trip.

3. The apparatus of claim 2, wherein the vehicle apparatus is configured to provide the planned route via a display of the vehicle apparatus.

4. The apparatus of claim 2, wherein the vehicle apparatus is configured to control one or more systems of a corresponding vehicle in accordance with the conflict-resolved travel plan.

5. The apparatus of claim 1, wherein the conflict-resolved travel plan comprises user preferences for the first user, the user preferences determined based on a user behavior pattern database.

6. The apparatus of claim 1, wherein the supplemental trip data comprises at least one of expected energy consumption of the first trip, vehicle diagnoses or prognosis information for a vehicle to be used for the first trip, vehicle maintenance information associated with the first trip, expected driving effort of the first trip, expected weather information corresponding to the first trip, expected travel time for the first trip, a planned route for the first trip, expected traffic information corresponding to the first trip, a planned beginning time of the first trip, or first user behavior pattern information.

7. The apparatus of claim 1, wherein:
if the second travel plan is an existing travel plan, the second travel plan is determined based on second trip data received from a second user apparatus corresponding to the second user, and
if the second travel plan is an expected travel plan, the second travel plan is determined based on a user behavior database.

8. A method comprising:
receiving trip plan data from a user apparatus corresponding to a first trip to be taken by a first user;
determining supplemental trip data corresponding to the trip plan data based at least in part on map data;
generating a first travel plan based at least in part on the trip plan data and the supplemental trip data;
identifying a second travel plan associated with a second user, the second travel plan being an existing travel plan or an expected travel plan that conflicts with the first travel plan;
based on (a) a collaboration level corresponding to the first user and the second user, (b) the first travel plan, and (c) the second travel plan, generating a conflict-resolved travel plan that resolves the conflict between the first travel plan and the second travel plan; and
providing the conflict-resolved travel plan to a vehicle apparatus prior to the first user beginning the first trip.

9. The method of claim 8, wherein the collaboration level indicates a priority of a trip to be taken by the first user with respect to a trip to be taken by the second user.

10. The method of claim 8, wherein the collaboration level comprises a first set of features available to the first user corresponding to the second user.

11. The method of claim 8, wherein the conflict-resolved travel plan comprises a planned route for the first trip.

12. The method of claim 11, wherein the vehicle apparatus is configured to provide the planned route via a display of the vehicle apparatus.

13. The method of claim 11, wherein the vehicle apparatus is configured to control one or more systems of a corresponding vehicle in accordance with the conflict-resolved travel plan.

14. The method of claim 8, wherein the conflict-resolved travel plan comprises user preferences for the first user, the user preferences determined based on a user behavior pattern database.

15. The method of claim 8, wherein the supplemental trip data comprises at least one of expected energy consumption of the first trip, vehicle diagnoses or prognosis information for a vehicle to be used for the first trip, vehicle maintenance information associated with the first trip, expected driving effort of the first trip, expected weather information corresponding to the first trip, expected travel time for the first trip, a planned route for the first trip, expected traffic information corresponding to the first trip, a planned beginning time of the first trip, or first user behavior pattern information.

16. The method of claim 8, wherein:
if the second travel plan is an existing travel plan, the second travel plan is determined based on second trip data received from a second user apparatus corresponding to the second user, and
if the second travel plan is an expected travel plan, the second travel plan is determined based on a user behavior database.

17. The method of claim 8, further comprising updating a user behavior database based on (a) the trip plan data, (b) the conflict-resolved travel plan, (c) user conflict resolution choices, or (d) a combination thereof.

18. The method of claim 8, wherein generating the conflict-resolved travel plan comprises at least one of:
requesting and receiving feedback from at least one of (a) the first user via the first user apparatus or (b) the second user via the second user apparatus,
application of a collaboration level corresponding to the first user and the second user, and
generating a combined trip that comprises the first trip and the second trip.

19. The method of claim 8, wherein the collaboration plan comprises vehicle preference information for at least one of the first user and the second user and the conflict-resolved travel plan comprises a vehicle assignment for at least one of the first trip or the second trip.

20. A computer program product comprising at least one non-transitory computer-readable storage medium having computer-executable program code instructions stored therein with the computer-executable program code instructions comprising program code instructions configured to:
receive trip plan data from a user apparatus corresponding to a first trip to be taken by a first user;
determine supplemental trip data corresponding to the trip plan data based at least in part on map data;
generate a first travel plan based at least in part on the trip plan data and the supplemental trip data;
identify a second travel plan associated with a second user, the second travel plan being an existing travel plan or an expected travel plan that conflicts with the first travel plan;
based on (a) a collaboration level corresponding to the first user and the second user, (b) the first travel plan, and (c) the second travel plan, generate a conflict-resolved travel plan that resolves the conflict between the first travel plan and the second travel plan; and
provide the conflict-resolved travel plan to a vehicle apparatus prior to the first user beginning the first trip.
